(19) United States
(12) Patent Application Publication
(10) Pub. No.: US 2023/0389543 A1
(43) Pub. Date: Dec. 7, 2023

(54) SOLID PHASE MATRIX FOR CROP PROTECTION

(71) Applicant: North Carolina State University, Raleigh, NC (US)

(72) Inventors: Richard H. GUENTHER, Raleigh, NC (US); Saad A. KHAN, Raleigh, NC (US); Charles H. OPPERMAN, Raleigh, NC (US); Lokendra PAL, Raleigh, NC (US); Tim L. SIT, Raleigh, NC (US); Eric Lee DAVIS, Raleigh, NC (US); Tahira PIRZADA, Raleigh, NC (US)

(21) Appl. No.: 18/249,111

(22) PCT Filed: Oct. 11, 2021
(86) PCT No.: PCT/US2021/071810

§ 371 Date: Apr. 14, 2023

Related U.S. Application Data
(60) Provisional application No. 63/092,250, filed on Oct. 15, 2020.

(51) Int. Cl. A01N 25/34; D21H 11/14; D21H 11/12; A01N 43/90; A01N 43/40; D21B 1/14; D21B 1/06

(52) U.S. Cl. CPC A01N 25/34; D21H 11/14; D21H 11/12; D21B 1/068; A01N 43/40; D21B 1/14; A01N 43/90

(57) ABSTRACT

Disclosed herein is a solid phase matrix comprising a layer of lignocellulosic fibers that can be used as effective cargo delivery for crop protection. Also disclosed is a mechanized planter for wrapping or encasing a plant seed, seed piece, seedling, or slip into the disclosed solid phase matrix. Also disclosed is a method for protecting a plant or plant that involves wrapping or encasing the plant or plant part in the disclosed solid phase matrix.

### CROSS-REFERENCE TO RELATED APPLICATIONS

This application claims benefit of U.S. Provisional Application No. 63/092,250, filed Oct. 15, 2020, which is hereby incorporated herein by reference in its entirety.

### BACKGROUND

Increasing quantity and quality of food and fiber crops worldwide is a significant challenge in the face of changing climate, increased urbanization, and reductions in arable land for food production. Vagaries in rainfall associated climate change drive the dynamics of land use patterns that may negatively impact agricultural production. Increased urbanization and reductions in arable land for food production stress existing social organization and agroecosystems. The need for improvements in crop production and quality is especially acute in the regions of the developing world. For example, food security and safety for an expanding population in much of Africa and other underdeveloped parts of the world is essential. Greater yield and more stable production on existing land through sustainable crop management can also improve quality, stability, and storage capacity of food systems. All components of food safety and security can benefit from the implementation of better pest management techniques. An important, yet often neglected, constraint to production of all crops are the losses in yield potential that can be attributed to plant-parasitic nematodes.

There is need in agriculture to increase production while reducing its impact on the environment. The next generation of agrochemicals need formulations that reduce the amount of agrochemicals required, eliminate plastics in their formulations, increase the safety to farmers, control the release of active ingredient, reduce the amount of energy used in application, are effective in the control of emerging pathogens in addition to increasing yield.

### SUMMARY

Disclosed herein is a solid phase matrix comprising a layer of lignocellulosic fibers that can be used as effective cargo delivery for crop protection. In some embodiments, 30%, 35%, 40%, 45%, 50%, 60%, 70%, 80%, 90%, or 100% of the lignocellulosic fibers have an average length of from 0.5 to 50 mm, 0.5 to 20 mm, 0.5 to 10 mm, 5 to 50 mm, 10 to 50 mm, 10 to 20 mm, 5 to 10 mm, or 2 to 8 mm, including an average length of 0.5, 1, 2, 3, 4, 5, 6, 7, 8, 9, 10, 11, 12, 13, 14, 15, 16, 17, 18, 19, 20, 25, 30, 35, 40, 45, or 50 mm.

In some embodiments, the lignocellulosic fibers contain banana pulp fibers in an amount of from 10 wt % to 90 wt %, 10 wt % to 50 wt %, or 50 wt % to 90 wt % of the solid phase matrix, including 10 wt %, 15 wt %, 20 wt %, 25 wt %, 30 wt %, 35 wt %, 40 wt %, 45 wt %, 50 wt %, 60 wt %, 70 wt %, 80 wt %, or 90 wt %.

In some embodiments, the remainder of the lignocellulosic fibers involves wood or recovered paper fibers, such as old corrugated cardboard (OCC) or mixed office waste (MOW). In some embodiments, the remainder of the lignocellulosic fibers involves fibers from non-banana plants, such as wheat, rice, bagasse, grasses, gampi, rush, mulberry, and bamboo or some combination thereof. In some other embodiments, the remainder of the lignocellulose fibers involves fibers from seed-hair fibers, leaf fibers, bast fibers and some combination thereof.

In some embodiments, the matrix has an air resistance of less than 500, 200, or 100 G.s, ranging from 1 to 500 G.s, or from 10 to 100 G.s, including 1, 2, 3, 4, 5, 6, 7, 8, 9, 10, 20, 25, 30, 35, 40, 45, 50, 60, 70, 80, 90, 100, 110, 120, 130, 140, 150, 160, 170, 180, 190, 200, 250, 300, 350, 400, 450, or 500 G.s.

In some embodiments, the matrix has a water sorbency of at least 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 ml/gm.

In some embodiments, the matrix has a water absorbency of at least 0.01, 0.05, 0.1, 0.2, 0.3, 0.4, 0.5, 0.6, 0.7, 0.8, 0.9, or 1.0 ml/gm.

In some embodiments, the matrix has a burst index less than 15, 14, 13, 12, 11, 10, 9, 8, 7, 6, 5, 4, 3, 2, 1, or 0.5 kPa·m²/g before punching holes in the matrix.

In some embodiments, the matrix has a tear index of 0.205 to 30.0 mN·m²/g or 1.0-20 mN·m²/g or 6.5-18.5 mN·m²/g, including a tear index of 0.20, 0.50, 1.0, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 21.5, 22.0, 22.5, 23.0, 23.5, 24.0, 24.5, 25.0, 25.5, 26.0, 26.5, 27.0, 27.5, 28.0, 28.5, 29.0, 29.5, or 30.0 mN·m²/g.

In some embodiments, the matrix has a basis weight less than 15, 20, 25, 35, 45, 50, 55, 60, 65, 70, 75, 80, 85, 90, 95, 100, 105, 110, 115, 120, 125, 130, 135, 140, 245, 150, 155, 160, 165, 170, 175, 180, 185, 190, 195, or 200 gsm.

In some embodiments, the matrix retains integrity in soil for at least 7, 14, 21, 25, 30, 35, or 40 days but not longer than 50, 60, 70, 80, 90, or 100 days.

In some embodiments, the matrix has a thickness less than 15, 25, 50, 75, 100, 150, 200, 250, 300, 350, or 400 μm.

In some embodiments, the banana pulp fibers are derived from the banana plant rachis, penducle, pseudostem, fruit peel raw materials, banana leaves, or any combination thereof. In some embodiments, the banana pulp fibers are derived from the banana plant rachis, penducle, pseudostem, fruit peel raw materials, banana leaves or any combination thereof. In some embodiments, the banana pulp fibers are derived from common cultivars such as Cavendish or Musa cavendishii, Musa acuminate, Musa balbisiana, Musa sikkimensis, Musa basjoo, other cultivars. In some embodiments. In some embodiments, the raw materials is mixed cultivars. In some embodiments, the raw materials are cleaned, screened and disintegrated mechanically to make banana fibers. In some embodiments, the raw materials are disintegrated mechanically after soaking in water and screened to make banana fibers. In some embodiments, the raw materials are cut in small pieces and soaked in water at elevated temperatures before mechanically disintegrating and screening to make banana fibers. In some embodiments, the raw materials are cut in 10 to 50 mm pieces, soaked in a 1:8 to 1:4 solids to water ratio at elevated temperatures before mechanically disintegrating and screening to make banana fibers. In some embodiments, the banana pulp fibers are derived after soaking the raw materials at 60° C., 80° C., 90° C., 100° C., 110° C., 120° C., 130° C., 140° C., 150° C., 160° C., 170° C., 180° C., 190° C. or higher temperatures before mechanically disintegrating and screening to make banana fibers. In some embodiments, the banana pulp fibers are derived after soaking the raw materials at elevated temperatures for 1 hour or 2 hours or 3 hours or 4 hours or 12 hours or 24 hours or 72 hours or more before mechanically disintegrating and screening to make banana fibers. In some embodiments, the banana pulp fibers are mechanically refined after disintegration and screening. In some embodiments, the banana pulp fibers are produced from a pulp having a Canadian Standard Method (CSF) test freeness of at least 300, 350, 400, 450, or 500, including from 300-700, or 500 to 650 mL.

In some embodiments, the banana paper is produced from a pulp having a Canadian Standard Method (CSF) test freeness of at least 300, 350, 400, 450, or 500, including from 300-700, or 500 to 650 mL. In some embodiments, the banana paper is produced from a pulp having a basis weight of 15, 20, 30, 40, 50, 60, 70, or 80, or 60 to 70 gsm using a British Hand Sheet molding machine. In some embodiments, the banana paper is produced from a pulp having a basis weight of 60, 70, or 80, or 60 to 76 gsm using a Fourdrinier paper machine.

In some embodiments, the paper matrix has a small molecule absorbance capacity of at least 0.01, 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, or 5.0 mg/gm or higher for neutral compounds.

In some embodiments, the paper matrix has a small molecule absorbance capacity of at least 200, 210, 220, 230, 240, 250, 260, 270, 280, 290, 300, 310, 320, 330, 340, 350, 360, 370, 380, 390, or 400 μg/gm for positively charged compounds.

In some embodiments, the paper matrix has a small molecule absorbance capacity of at least 100, 110, 120, 130, 140, 145, 150, 155, 160, 165, 170, 175, 180, 185, 190, 195, or 200 μg/gm for negatively charged compounds. Therefore, in some embodiments the matrix also contains an agrochemical internalized to the solid phase matrix. The agrochemical can in some embodiments, be any chemical suitable for use in agriculture, such as a small molecule or macromolecule. For example, in some embodiments, the agrochemical is a pesticide, herbicide, nematocide, fungicide, insecticide, micronutrients, fertilizer, or plant growth regulator. In particular embodiments, the agrochemical is abamectin or fluopyram.

In some embodiments, the half-life of the agrochemical in the soil is increased by at least 100%, 110%, 120%, 130%, 140%, 150%, 160%, 170%, 180%, 190%, 200% when absorbed into the solid phase matrix.

In some embodiments, the matrix also contains microorganisms, such as nitrogen-fixing bacteria and fungi.

The fiber bonding properties of the matrix may also be improved by treatment with chemical additives. Therefore, in some embodiments, the layer of lignocellulosic fibers further includes a dry strength additive such as a starch.

The fiber wettability and integrity in the water and soil may also be improved by treatment with chemical additives. The predominant treatment for reducing wettability of fibers, particularly water absorption, have been alkyl ketene dimer (AKD) or rosin sizing agents to the pulp fiber slurry prior to the sheet forming operation. Therefore, in some embodiments, the layer of lignocellulosic fibers may further includes a sizing agent such as AKD.

The disclosed matrix can be configured into a variety of shapes depending on the intended purpose. For example, in some cases the disclosed matrix is folded into a pouch sized to accommodate a root stock, plant seed, seed piece, seedling, or slip. In some cases the matrix is configured as a liner in a planting container. In some cases the matrix is configured in a multilayer and form the planting container. The matrix can be a sheet, web, pouch, sleeve, tube, envelope, liner, container, shredded or configured as a pellet for sustained release of an agrochemical in or on soil.

Also disclosed herein is a mechanized planter that involves: 1) a hopper configured to be filled with a plant seed, seed piece, seedling, or slip, 2) a hopper configured to feed the solid phase matrix of any one of claims 1 to 21, 3) a mechanism for wrapping or encasing the plant seed, seed piece, seedling, or slip into the solid phase matrix, and 4) a mechanism for planting the wrapped or encased plant seed, seed piece, seedling, or slip into a soil.

Also disclosed herein is a method for protecting a plant or plant part that involves wrapping or encasing the plant or plant part in the disclosed solid phase matrix.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A shows the effect of pulp refining on the structure of the solid phase matrix as visible from the change in appearance of handsheets. FIGS. 1B and 1C show change in thickness and air resistance with refining time (FIG. 1B) and strength in terms of burst and tear indices of the respective handsheets (FIG. 1C).

FIG. 2A contains SEM images (at various magnifications) of the fibrillar structure in raw banana fiber. FIG. 2B contains SEM micrographs of handsheets prepared from 2 (a,e), 5 (b,f), 10 (c, g) and 30 (d,h) minutes refined pulp. FIGS. 2C and 2D shows fiber quality analysis showing fiber count (FIG. 2C) and mean kink index and coarseness (FIG. 2D) of the pulp refined for 1, 2, 3, 5, 10, 20 and 30 minutes.

FIG. 3A shows rhodamine B release profile of P1 (liner paper), P2, P3 & P4 (different banana papers) and P5 (copy paper). For ease of understanding, the points are connected through lines (Error bars indicate standard deviation, n=3). FIG. 3B shows lignin content, density, contact angle and air resistance of P1, P2, P3, P4 and P5. FIG. 3C shows SEM micrographs of surface sections (a-d) and cross sections (e-h) of P1 (a,e), P3 (b,f), P4 (c,g) and P5 (d,h).

FIG. 4A shows Abm release from P1 (liner paper), P2, P3, P4 (different banana papers) and P5 (copy paper). FIG. 4B is a schematic to display experiment design for in-vitro study to measure bioavailability of Abm, FIG. 4C shows time dependent bioavailability of Abm from P1, P2, P3, P4 and P5. (Error bars in FIGS. 4A and 4C indicate standard deviation, n=3).

FIG. 5 shows various stages involved in production of paper from banana rachis (from left to right). Starting with crushed banana fibers which are mechanically crushed (refined) after mixing in water in specific concentration. The fibrous slurry is converted to handsheets by separating water from the fibers in the paper making mold. The handsheets are stacked in drying rings for holding the sheets against the discs to retain a proper shape while drying.

FIG. 6 shows soaking of paper in a specific concentration of RhB solution. Dye release schematic displays gradual increase in the color and its intensity (from left to right) when dye loaded paper is soaked in water.

FIG. 7A shows surface sections (top row) and cross sections (bottom row) SEM images of handsheets prepared from 1 (A, a), 2 (B,b) and 20 (C, c) minutes refined pulp. FIG. 7B shows surface (top part) and cross sections (bottom part) SEM images of paper prepared (a) stalk, (b) peduncle and (c) rachis removed from the banan plant (musa germplasm) in Arusha. FIG. 7C shows surface (top) and cross-section (bottom) SEM images paper produced from fibers removed form pseudostems of various species of banana plants (Musa Basjoo, Musa Sikkimensis and Musa Balbisiana) collected from North Carolina. FIG. 7D shows SEM images of the surface (top) and cross sections (bottom) of paper produced from fibers removed from various banana plants (Kitooke Kiganda, Mbwazirume, Nakanyaoga, and Sukali Ndiizi) collected from Uganda. FIG. 7E shows SEM images of the surface (top) and cross sections (bottom) of paper produced from a mix of banana fiber with (1) dry peels and (b) wet peels in a 80:20 ratio. FIG. 7F shows SEM images of the surface (top) and cross sections (bottom) of paper produced from (a) bagasse and a mix of bagasse with banana fiber in (b) 20:80 and (c) 40:60 composition. FIG. 7G shows SEM surface (top) and cross-sections (bottom) of paper produced from pulp containing banana fiber and old corrugated boxes (OCC) in (a) 80:20, (b) 60:40, (c) 40:60, and (d) 20:80 ratio by weight.

FIG. 8 shows root penetration studies (Panel A) setup after 2 weeks, showing the effect of reefing on root-germination (higher % root germination for 5 minutes refining), (Panel B) roots coming from the side of 30 minutes refined paper (Panel C) roots penetrating out of 5 minutes refined paper.

FIGS. 9A to 9L show HPLC chromatograms obtained to study release of abamectin (Abm) after soaking Abm loaded matrices in water for 1 hour (FIGS. 9A & 9G), 10 hours (FIGS. 9B & 9H), 24 hours (FIGS. 9C & 9I), 48 hours (FIGS. 8D & 8J), 120 hours (FIGS. 9E & 9K), and 240 hours (FIGS. 9F & 9L). FIGS. 9A-9F display Abm release from P1 (Liner paper) while FIGS. 9G-9L show Abm release profile of P2 (banana paper).

FIGS. 10A to 10L show HPLC chromatograms obtained to study release of abamectin (Abm) after soaking Abm loaded matrices in water for 1 hour (FIGS. 10A & 10G), 10 hours (FIGS. 10B & 10H), 24 hours (FIGS. 10C & 10I), 48 hours (FIGS. 10D & 10J), 120 hours (FIGS. 10E & 10K), and 240 hours (FIGS. 10F & 10L). FIGS. 10A-10F display Abm release from P3 (banana paper) while FIGS. 10G-10L show Abm release profile of P4 (banana paper).

FIGS. 11A to 11F show HPLC chromatograms obtained to study release of abamectin (Abm) after soaking Abm loaded P5 matrices (copy paper) in water for 1 hour (FIG. 11A), 10 hours (FIG. 11B), 24 hours (FIG. 11C), 48 hours (FIG. 11D), 120 hours (FIG. 11E), and 240 hours (FIG. 11F).

FIG. 12 shows yam yield in mt/ha as influenced by wrap and plant treatments: abamectin treated banana paper (PA), paper only (PO), and farmer practice (FP) in Benin from 2015-2018 (least significant difference 0.34, α 0.01).

FIG. 13 shows yam dry rot on a 1-5 scale as influenced by wrap and plant treatments: abamectin treated banana paper (PA), paper only (PO), and farmer practice (FP) in Benin from 2015-2018. Least significant difference=0.10, alpha 0.01).

FIG. 14 is a plot of the covariance of yam yield in grams per M2 in response to pre-plant density of root-knot nematode (Meloidogyne spp.) from 2015 to 2016.

FIG. 15 is a plot of covariance of yield versus initial population density of Scutellonema bradys on yam dry rot (1-5 Scale) from 2015-2016.

FIG. 16 is a yam tuber wt (g/tuber) at harvest and 3 months post harvestas influenced by wrap and plant treatments: abamectin treated banana paper (PA), paper only (PO), and farmer practice (FP) in Benin in 2016-18 (least significant difference 31.2 and 26.5 respectively α=0.01).

FIG. 17 shows influence of wrap and plant treatments: abamectin treated banana paper (PA), paper only (PO), and farmer practice (FP) in Benin from 2016-2018 on percent weight loss of tubers after 3 months storage. (least significant difference=0.81, α=0.01).

FIG. 18 shows influence of wrap and plant treatments: abamectin treated banana paper (PA), paper only (PO), and farmer practice (FP) in Benin from 2015-2018 on final population density (Pf0) and 2016-2017 density 3 months post-harvest (Pf3) of Scutellonema bradys per gram of yam peel (least significant difference=1.41, and 2.95 respectively α=0.01).

FIG. 19 shows reproductive factor (Rf3=population density at 3 months/initial {harvest} population density/g of yam peel) 3 months post-harvest for Scutellonema bradys as affected by plant and wrap treatments: PA paper+abamectin, PO paper only, and FP farmer practice from 2016-2018 (lsd=0.12, α=0.01).

FIG. 20A is a plot of Average Total Plot Weight by Treatment. FIG. 20B is a plot of Average Number of #1 Grade Tubers by Treatment. FIG. 20C is a plot of the Average Count of #1 Grade Tubers by Treatment. FIG. 20D is a plot of Average Number Count of Root Knot Nematode at Harvest by Treatment.

FIG. 21 (from left to right) shows less root galling from suckers wrapped with abamectin treated banana paper; root galling from suckers wrapped with Non-Treated banana paper; lesioned roots; clean roots

FIG. 22 shows the effect of ABA-banana treated paper on plant height (cm).

FIG. 23 shows the effect of Abamectin-banana treated paper on nematode population from roots and soil

FIG. 24A shows cassava germination/sprouting 4WAP. FIG. 24B shows sprouting 8WAP. FIG. 24C shows a harvested cassava tuber. FIG. 24D shows cassava tubers infected with tuber rot. FIG. 24E shows galling symptoms on cassava roots.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biology, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### Solid Phase Matrix

The disclosed solid phase matrix is produced by a multistep process. First, lignocellulosic materials are harvested to provide the needed fibers. In some embodiments, the lignocellulosic fibers contain banana pulp fibers in an amount of from 10 wt % to 90 wt %, 10 wt % to 50 wt %, or 50 wt % to 90 wt % of the solid phase matrix, including 10 wt %, 15 wt %, 20 wt %, 25 wt %, 30 wt %, 35 wt %, 40 wt %, 45 wt %, 50 wt %, 60 wt %, 70 wt %, 80 wt %, or 90 wt %. The remainder of the lignocellulosic material can include, for example, paper waste, wood, particle board, sawdust, silage, grasses, rice hulls, bagasse, cotton, jute, hemp, flax, bamboo, sisal, abaca, straw, corn cobs, corn stover, switchgrass, alfalfa, hay, rice hulls, coconut hair, cotton, seaweed, algae, and mixtures thereof. In particular embodiments, old corrugated cardboard (OCC) is used.

In some embodiments, the rachis from the banana plant are gathered, crushed, and then blended with the other fibers, such as old corrugated cardboard (OCC). The fibers may be prepared by any known defiberization or pulping process, such as, mechanical or chemical pulping processes. Suitable pulping methods include the refiner mechanical process, thermos-mechanical process, autohydrolysis process, soda process, and Kraft process. The banana fibers may also be mechanically pulped, thermo-mechanically pulped, chemi-thermo-mechanically pulped, or chemically pulped. In some embodiments, the raw materials are cleaned, screened and disintegrated mechanically to make banana fibers. In some embodiments, the raw materials are disintegrated mechanically after soaking in water and screened to make banana fibers. In some embodiments, the raw materials are cut in small pieces and soaked in water at elevated temperatures before mechanically disintegrating and screening to make banana fibers. In some embodiments, the raw materials are cut in 10 to 50 mm pieces, soaked in a 1:8 to 1:4 solids to water ratio at elevated temperatures before mechanically disintegrating and screening to make banana fibers. In some embodiments, the banana pulp fibers are derived after soaking the raw materials at 150° C. to 160° C. temperatures for 3 hours before mechanically disintegrating and screening to make banana fibers.

A matrix pulp stock may be made by incorporating the pulp fibers into a suitable amount of water to form a pulp slurry. For example, the slurry may contain about 2% fibers and 98% water. Other fibers may be added prior to or after forming the slurry. The slurry may be refined in valley beater or similar device. The refiner applies mechanical and hydraulic forces to alter the fibers within the water slurry. For example, the refining process may cause one or more of the following: fiber shortening, fibrillation (internal and external), removal of the primary walls, and the formation of fiber debris. Refining may be accomplished to achieve the desired physical attributes (such as porosity, density, burst, tear and tensile) for root germination and effective uptake and release of pesticides. The refining intensity can be measured using a freeness tester (e.g., targeting a certain freeness number according to the Canadian Standard Method (CSF) test). As an example, refining of the solid phase matrix stock is targeted to a CSF of at least 300, 350, 400, 450, or 500, including from 300-700, or 500 to 650 for the banana fibers.

After beating or refining, the slurry may also be passed through a screen, which removes larger debris, but allows the desired size fibers to pass through the screen. The solid phase medium may be made using any suitable papermaking process. In an example, the solid phase matrix is formed using a British handsheet mold as per the T 205 Tappi Method. In another example, the solid phase medium is formed using a continuous process on a Fourdrinier paper machine. The Fourdrinier paper machine consists of a headbox that delivers a stream of dilute fibers on to a continuously moving wire belt. The water drains through the wire, thereby forming a wet mat of fibers. The fiber mat is then pressed and dried. Subsequent operations may add surface sizing additives to control the matrix's strength, uptake and release of the pesticides. Solid phase medium made by a continuous process, such as Fourdrinier paper machine has directionality. The Machine Direction (MD) of the solid phase matrix corresponds to the direction the wire travels. The Cross Direction (CD) of the solid phase matrix refers to the direction perpendicular to the direction the wire travels. Some physical properties of the solid phase matrix, such as the tear or tensile, will have different values in the MD versus CD.

The fiber bonding properties of the matrix may also be improved by treatment with chemical additives. The predominant treatment for improving strength, particularly dry strength, of paper or board has so far been to add cationic starch to the pulp fiber slurry prior to the sheet forming operation. Therefore, in some embodiments, the layer of lignocellulosic fibers further includes a dry strength additive such as a starch. The fiber wettability and integrity in the water and soil may also be improved by treatment with chemical additives. The predominant treatment for reducing wettability of fibers, particularly water absorption, have been alkyl ketene dimer (AKD) or rosin sizing agents to the pulp fiber slurry prior to the sheet forming operation. Therefore, in some embodiments, the layer of lignocellulosic fibers may further includes a sizing agent such as AKD.

The solid phase matrix can be further processed to contain a releasable active ingredient, such as an agrochemical. The agrochemical can in some embodiments, be any chemical suitable for use in agriculture, such as a small molecule or macromolecule. For example, in some embodiments, the agrochemical is a pesticide, herbicide, nematocide, fungicide, insecticide, micronutrients, fertilizer, or plant growth regulator. In particular embodiments, the agrochemical is abamectin or fluopyram.

In some embodiments, the solid phase matrix is sprayed with a solution containing the agrochemical(s), which is then allowed to dry. In some embodiments, the solid phase matrix is first perforated. For example, holes with an average diameter of about 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mm are created at a density of about 1, 2, 3, 4, 5, 6, 7, 8, 9, 10, 11, 12, 13, 14, 15, 16, 17, 18, 19, 20, 25, 30, 35, 40, 45, 50, 60, 70, 80, 90, 100 holes per 100 cm². In some embodiments, the solid phase matrix with higher basis weights has larger or more holes when compared to low basis weights to allow the root germination.

The disclosed matrix can be configured into a variety of shapes depending on the intended purpose. For example, in some cases the disclosed matrix is folded into a pouch sized to accommodate a root stock, plant seed, seed piece, seedling, or slip. In some cases the matrix is configured as a liner in a planting container. The matrix can be a sheet, web, pouch, sleeve, tube, envelope, shredded or configured as a pellet for sustained release of an agrochemical in or on soil.

A number of embodiments of the invention have been described. Nevertheless, it will be understood that various modifications may be made without departing from the spirit and scope of the invention. Accordingly, other embodiments are within the scope of the following claims.

### Examples

### Example 1: Tailored Lignocellulose Based Biodegradable Matrices with Effective Cargo Delivery for Crop Protection

Worldwide awareness for the conservation of natural resources is leading to the use of various non-wood plant fibers as alternatives to wood pulp in the manufacture of paper and paperboard (Ai, J., et al. Bioresour. Technol. 2010, 101 (1), 215-221; Mazhari Mousavi, S. M., et al. J. Clean. Prod. 2013, 52, 420-424; Xiang, Z., et al. Cellulose 2017, 24 (11), 5147-5156; Laftah, W. A., et al. J. Mater. Res. Technol. 2015, 4 (3), 254-261). Materials derived from non-wood plants (also known as lignocellulosic materials) primarily consist of three important components: cellulose (35-50%), hemicellulose (20-35%), and lignin (10-25%) (Malherbe, S., et al. Rev. Environmental Sci. Biotechnol. 2002, 1 (2), 105-114). Cellulose is responsible for imparting mechanical strength to the plant; hemicellulose is capable of developing interfiber bonds; while lignin is the major hydrophobic component of plant fibers consisting of phenyl propane units and is associated with the natural decay resistance of the plants (Khan, M. Z. H., et al. J. Nat. Fibers 2014, 11 (3), 199-211). Among various non-woody plants, fiber removed from the banana plant (Musa spp.) is found to consist of a comparatively higher content of cellulose (44-54%) with a low amount of lignin (6-13%) (Pereira, A. L. S., et al. BioResources 2014, 9 (4), 7749-7763; Li, K., et al. BioResources 2010, 5 (2), 576-585). Bananas are also the world's most exported fresh fruit (US$10 billion per year) with global exports (excluding plantains) reaching a record goal of 18.1 million tons in 2018. It is estimated that wastes produced by a single banana plant is 80% of its mass which is mostly used as animal feed or fuel (Pappu, A., et al. Int. J. Biol. Macromol. 2015, 79, 449-458; Padam, B. S., et al. J. Food Sci. Technol. 2014, 51 (12), 3527-3545). Generation of abundant wastes from banana harvest, taken together with comparatively low content of lignin and higher amount of cellulose, make the wastes of banana harvest attractive candidates for paper production (Li, K., et al. BioResources 2010, 5 (2), 576-585). Previously, considerable research has been conducted on sorption and release properties of products and/or wastes produced by plants like gums, rice husk, sawdust, jute and banana fiber (Bello, K., et al. Carbohydr. Polym. 2018, 181 (December 2017), 605-615; Ahmad, T., et al. J. Environ. Manage. 2018, 206, 330-348; Subha, V., et al. Polym. Sci. Ser. B 2016, 58 (1), 61-72; Salleh, M. A. M., et al. Desalination 2011, 280 (1-3), 1-13). Other than exploring the utility of banana fibers in composites and sorbent materials (Pappu, A., et al. Int. J. Biol. Macromol. 2015, 79, 449-458; Bello, K., et al. Carbohydr. Polym. 2018, 181 (December 2017), 605-615; Ahmad, T., et al. J. Environ. Manage. 2018, 206, 330-348; Venkateshwaran, N., et al. J. Reinf. Plast. Compos. 2010, 29 (15), 2387-2396; Chavez-Guerrero, L., et al. Cellulose 2019, 1, 3777-3786), recently some research groups have reported production of paper from banana fiber for various applications, including feminine hygiene products and wrapping paper (Khan, M. Z. H., et al. J. Nat. Fibers 2014, 11 (3), 199-211; Ramdhonee, A., et al. J. Environ. Chem. Eng. 2017, 5 (5), 4298-4306; Vishnuvarthanan, M., et al. Environ. Chem. Lett. 2019, 17 (3), 1429-1434). However, to the best of our knowledge, there has been no detailed research on understanding of the materials-process-structure-property-relationship of matrices produced from banana paper and other fibers and its role on the cargo release profile.

This study involved an in-depth examination of the impact of variation in physical characteristics of banana paper in order to engineer banana fiber-based biodegradable matrices capable of controlled release of loaded cargo molecules (such as pesticides) for better crop protection management in nematode infested soils. Pesticides have been an essential component of pest management schemes for many years, but concerns about environmental contamination and non-target impacts have led to increasing restrictions on broad-scale application. Generally, only about 10% of the pesticide is available to the crops while the remaining 90% becomes a part of the surrounding environment i.e., soil, water and air, resulting in damage to the environment as well as human health (Rahim, M., et al. Materials Science and Engineering; 2016; Wang, S., et al. J. Appl. Polym. Sci. 2017, 134(28), 45051). A controlled release of pesticide, or any other active ingredient, would be ideal to maintain its effective concentration over a stipulated period while applying lower initial volume. Recently, various approaches have been reported which are focused upon the utilization of either biopesticides or biodegradable release media for controlled release of pesticides (Rahim, M., et al. Materials Science and Engineering; 2016; Wang, S., et al. J. Appl. Polym. Sci. 2017, 134(28), 45051; Roy, A., et al. Cent. Eur. J. Chem. 2014, 12(4), 453-469; Chevillard, A., et al. J. Hazard. Mater. 2012, (205-216), 302-306; Farias, B. V., et al. Chem. Eng. 2019, 7, 19848-19856; Vurro, M., et al. Pest Manag. Sci. 2019, 75 (9), 2403-2412). In addition, different bio-based materials, such as lignin, chitosan, alginates and plant virus nanoparticles are also being considered for nanoencapsulation of agrochemicals (Cao, J., et al. ACS Appl. Mater. Interfaces 2015, 7 (18), 9546-9553; Maruyama, C. R., et al. Sci. Rep. 2016, 6, 19768; Falsini, S., et al. ACS Sustain. Chem. Eng. 2019, 7(24), 19935-19942; Kumari, A., et al. PLoS One 2012, 7 (7), e41230). However, the cost of the process involving complicated steps is a major barrier to applying these approaches on a large scale. The use of nanomaterials on the environment and human health are also limiting factors for implementation of the technology.

A unique wrap-and-plant (W&P) approach was used to explore the efficacy of banana fiber based matrices as controlled release media; wherein seed/seed pieces were wrapped with active ingredient impregnated banana paper and planted in the soil ensuring no impediment to seed germination. Without relying on high technology processing, the W&P approach is focused on facilitating sustainable crop protection for smallholder farmers across the developing world, without damaging the soil chemistry because of biodegradable nature of the seed wraps. This study involved (1) additive-free fabrication of various matrices from banana fibers via a basic paper making process, and (2) testing the developed matrices for their strength and release profile so that they can serve as effective seed wraps without any compromise on its integrity as well as the seed germination process. In contrast to a typical chemically-intensive paper making processes, the focus was to prepare the matrices from fibers produced from banana plants through mechanical modifications (beating and refining) and to study the effect of variations in refining on its strength, structure, and release profile. Mechanical modifications involves treatment of a specific concentration of fiber slurry in water through the application of compression and shear force on the fibers which results in several changes in their structure and properties as well as drainage, drying and machine runnability on continuous web operations, depending on the extent of refining (Gharehkhani, S., et al. Carbohydr. Polym. 2015, pp 785-803; Hafrên, J., et al. Wood Sci. Technol. 2014, 48 (4), 737-753).

Two different types of cargos i.e., rhodamine B (RhB) as a model molecule and abamectin (Abm) as a model pesticide, were used to study the release profile of paper. RhB is a water-soluble basic dye used in various biotechnology applications and also as a water tracer (Salleh, M. A. M., et al. Desalination 2011, 280 (1-3), 1-13). Abm is a macrocyclic lactone that exhibits strong activity against a variety of nematodes by paralyzing them by binding with their nerve and muscle cells (Cao, J., et al. Cellulose 2016, 23 (1), 673-687; Qiao, K., et al. Pest Manag. Sci. 2012, 68 (6), 853-857). One major drawback of using Abm for crop protection is its poor mobility due to its high binding capacity with soil and low water solubility, which makes it unavailable to the nematodes. Although it has been previously suggested that the phenyl propane units in lignin molecules are mainly responsible for the binding and release mechanism of the lignocellulose matrices for any cargo molecule (Cao, J., et al. Cellulose 2016, 23 (1), 673-687; Mulder, W. J., et al. Ind. Crops Prod. 2011, 34 (1), 915-920), these studies have not examined the effect of lignin content or other factors that may come into play. The structure and composition of the fiber may also play a significant role in determining its cargo release profile. Since paper-like matrices are being developed via additive-free processing of banana fiber, these matrices are referred to as paper or banana paper herein. For a better understanding of the process the release profiles of banana fiber-based matrices, banana paper was compared to two control non-banana papers with a noticeable difference in morphology and lignin content.

### Experimental Section

Materials: Banana fiber was procured from the agricultural industrial unit of Earth University, Costa Rica, where it was obtained by processing the wastes of banana harvest. Chopped parts of banana plant were biologically fermented with the inoculum of bacillus and actinomycetes, for five days. Later the fermented banana fibers were mixed with 95-98% water in agitation tanks and then cast as sheets, which are hydraulically pressed to remove moisture. The sheets were finally dried in the sun to reduce the moisture content to 7%, before shipment to North Carolina State University. Rhodamine B (RhB, ≥95%) dye was purchased from Millipore Sigma and used without further purification. For lignin content measurement, sodium thiosulphate solution (0.2 N), potassium iodide solution (1 N), sulfuric acid (4 N), potassium permanganate solution (0.1 N) and starch indicator were obtained from Fisher Scientific. Abamectin (Abm) (97%) was supplied by Alfa Aesar. Liner (P1) and copy (P5) papers that were used as controls were obtained. The recipe for nematode growth media (NGM) and M9 buffer was adapted from Wormbook (Stiernagle, T., In WormBook, ed. The C. elegans Research Community, WormBook). Caenorhabditis elegans (C. elegans) strain N2 (wild type) were obtained from the Caenorhabditis Genetics Center (CGC). Reagent grade acetone (99.5%) and HPLC grade acetonitrile (99.8%) were purchased from Millipore Sigma. Deionized water (pH: 5.77±0.13) was used throughout the experiments, except while making paper handsheets.

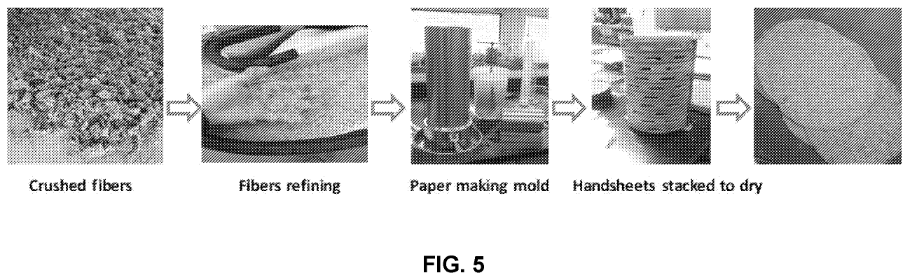

Handsheets production: Banana fibers were soaked in water overnight and were subsequently diluted to a 3% consistency (wt. % of fiber in the mixture) with tap water. The fibers were beaten for different intervals ranging from 1 to 30 minutes in a laboratory valley beater as per the TAPPI T200 standard method. To monitor changes in the fiber structure and drainage behavior, freeness of each sample of pulp was measured using Canadian Standard Freeness (CSF) tester as per the TAPPI T227 method. A standard laboratory British handsheet mold was used to prepare at least 10 circular handsheets (6.25 inches' diameter with a grammage of 70 g/m²) from the pulp following TAPPI T205 standard method. For ease of understanding, different handsheets are named according to preparation conditions, as shown in Table 1. After production, handsheets were conditioned at a temperature of 23° C. and a relative humidity of 50% according to TAPPI 402 (all the steps involved in paper production are shown in FIG. 5). Multiple samples of the handsheets were regularly tested for characterizing the release profile using RhB and Abm and the associated mortality of the model nematode C. elegans. Detailed information about the setup for the bioavailability assays is mentioned in the section on pesticide bioavailability.

Characterization: The lignin content of different types of fibers was measured by a thiosulphate oxidation process following TAPPI T236 test protocol. The burst strength of handsheets was tested with a MULLEN tester according to the TAPPI T810 test method. The internal tearing resistance (Elmendorf-type method) of the handsheets was tested with an L & W tester according to the TAPPI T 414 test method. The tensile strength was measured using an L&W tensile tester according to the T 494 test method. Air resistance of the handsheets (Gurley method) was measured according to the TAPPI T460 standard protocol. Fiber length, coarseness, fines content, and kink index were measured using the Fiber Quality Analyzer V1.5-RL644 CV-M4+IFC5.10 by OpTest Equipment Inc. according to the TAPPI T271 test method. A field emission scanning electron microscope, FESEM (Verios FE1) was used to characterize the morphology of the cross sections and surface sections of various types of paper. The samples were made conductive by coating with a 10-14 nm thick layer of gold prior to characterization while the acceleration voltage was kept at 2.0 kV. A First Ten Angstroms goniometer was used to determine water contact angle of a 2 μl droplet of water on the surface of various samples.

Root Penetration profile: To understand the effect of refining time on the strength of paper and the germination of seeds, a greenhouse trial was conducted using maize seeds. Banana papers produced from unrefined, 2, 5, 10, and 30 minutes refined pulp were used as the seed wraps. Each seed was wrapped with a 2×2 in² piece of paper and planted in sandy loam soil, which was watered at regular intervals. Each set consisted of ten replicates, and the trials were completed after 14 days.

Dye sorption & release profile: 10 μM solution of RhB was used to study the release and sorption profiles of 1×1 cm² pieces of paper in 10 ml of the dye solution while Thermo Scientific Genesys 10S UV-Vis spectrophotometer was used to measure the absorbance of the dye solution at 554.5 nm. All the measurements were conducted in triplicate. The dye sorption study was conducted by soaking the paper in the dye solution. The amount sorbed was measured using the following formula:

$$amount sorbed ( {q}_{s} ) = \frac{( Co - Ct ) V}{m} \qquad ( Eq . 1 )$$

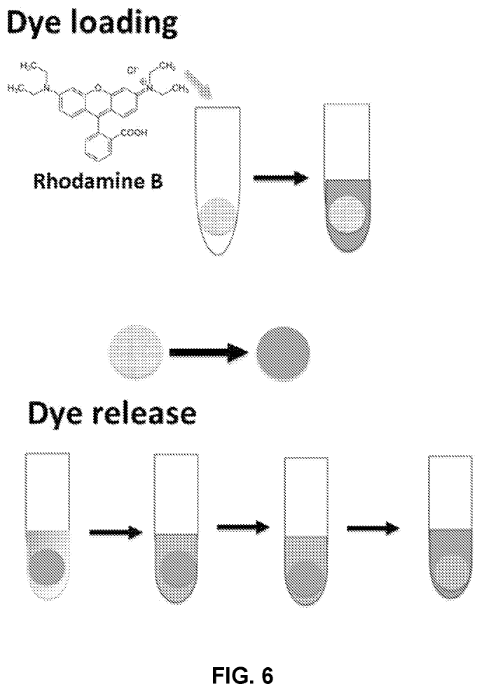

Here, C₀ is the initial concentration (mg/l) of the dye in the solution, Cₜ is the concentration (mg/l) at time t, V is the volume of dye solution in liters, and m is the mass of paper in g. The dye release profile was measured by soaking the dye loaded paper in 10 ml of deionized water (DI) and measuring the absorbance of DI after removing the paper after regular intervals starting from 20 minutes to 2 weeks (schematic in FIG. 6).

To minimize the contribution of variation in the sorption profile of each type of paper, the percent release profile of each type of paper was plotted against time.

% RhB released=(100qᵣ)/qₛ (Eq. 2)
where, qᵣ is the amount of dye released (mg/g) and qₛ is the dye sorbed on each type of paper.

Abm release profile: Following an established protocol (Gharehkhani, S., et al. Carbohydr. Polym. 2015, pp 785-803), a dilution of Abm from a 2 mg/ml stock solution in acetone was prepared in order to achieve a final concentration of 32.5 μg of Abm/m² on each sample after spraying. Using circular disks of 7 mm diameter from different samples of paper, the disks were soaked in 3 ml of DI in closed vials and left on a VWR rocking platform at a rate of 6 rpms to ensure homogenous mixing of the active ingredient in the release medium. All experiments were conducted in triplicate. The vials were removed from the rocking platform after regular intervals ranging from 30 minutes to 2 weeks and aliquots were removed from each vial for the quantification of Abm through high pressure liquid chromatography (HPLC). A Shimadzu high performance liquid chromatograph (HPLC) equipped with an autosampler and a diode array UV-Vis detector was used to determine the concentration of Abm, for which a Phenomenex Kinetex C18 column (150×4.6 mm², 2.6 um particle size) was suitable. The column temperature was held at 40° C., whereas the mobile phase was a mixture of 80% acetonitrile and 20% deionized water with a flow rate of 1.0 mL/min. An optimal absorbance wavelength of 245 nm was applied to the detector, while the injection volume was 10 uL in each case. % Abm released was determined through the following formula:

% Abm released=(100Qᵣ)/Qₛ (Eq. 3)

where Qᵣ is the amount of Abm released (g) and total amount of Abm loaded (μg) on each sample.

Abm bioavailability using bio-assays: The bioavailability studies were conducted using C. elegans strain N2 as model nematodes. C. elegans are generally used as standard bioassays to test the efficacy of a nematicide or of a delivery vehicle carrying the nematicide (Farias, B. V., et al. Chem. Eng. 2019, 7, 19848-19856; Cao, J., et al. ACS Appl. Mater. Interfaces 2015, 7 (18), 9546-9553; Cao, J., et al. Cellulose 2016, 23 (1), 673-687). This stems from the biotrophic nature of most plant parasitic nematodes and similar response to nematicides by C. elegans as by typical parasitic nematodes. C. elegans were cultured on nematode growth media (NGM) plates seeded with E. coli strain NA22. E. coli are added to provide nutrition for healthy growth of C. elegans. Healthy C. elegans nematodes exhibit characteristic flexible form and undulating movement. Abm serves as a paralytic to the nematodes which show rigid movement and linear shapes (immobilized) (Cao, J., et al. Cellulose 2016, 23 (1), 673-687). For this study, 7 mm diameter of the Abm-sprayed paper was fixed inside the barrel of a 1 ml luer lock syringe, and each paper was soaked with 400 μl of sterile phosphate buffered saline (PBS) solution for 1, 2, 3 and 4 hours. After the respective timeframe, the PBS solution was drained from the syringe into labelled wells of sterile 24 well flat bottom plates. C. elegans dispersed in 20 μl M9 buffer were then added into individual wells. After 24 hours, the mortality of the nematodes in the respective PBS buffer containing wells was measured with the help of a dissecting microscope. The percent (%) mortality of C. elegans in each case was determined from the number of immobile (rigid movement and linear shape) nematodes as compared to total number of nematodes in the well, using the following relation:

$$\% mortality = \frac{100 * number of immobilized C . elegans}{total number of C . elegans added} \qquad ( Eq . 4 )$$

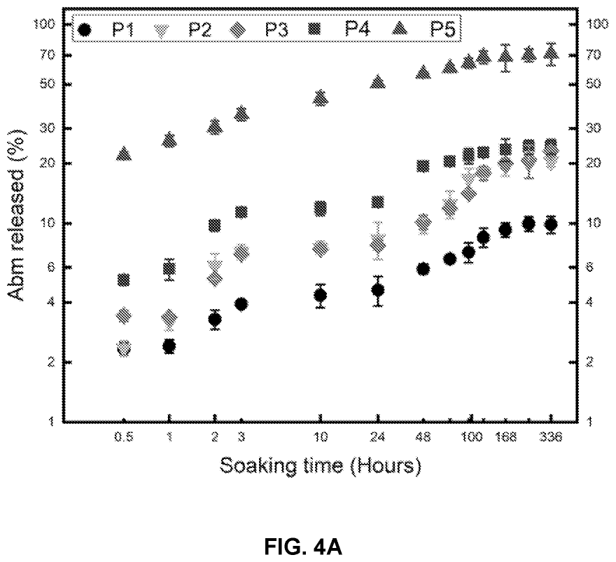

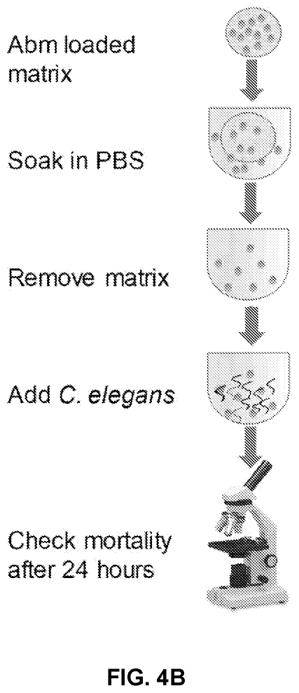

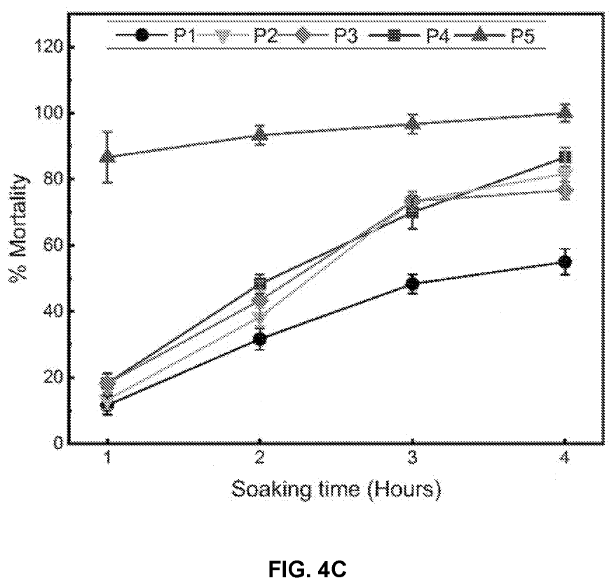

All experiments including the controls (PBS with paper without Abm and PBS only without paper or Abm) were conducted in triplicate. A detailed schematic explaining the experimental setup for the bioavailability studies is shown in a subsequent section (FIG. 4B).

### Results & Discussion

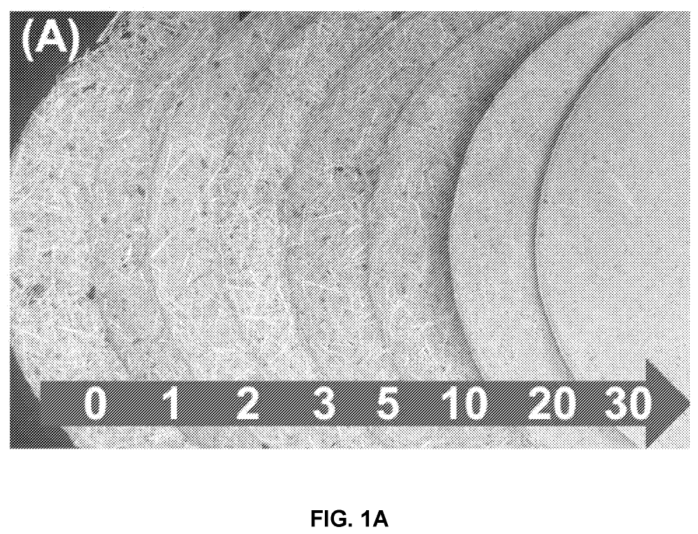

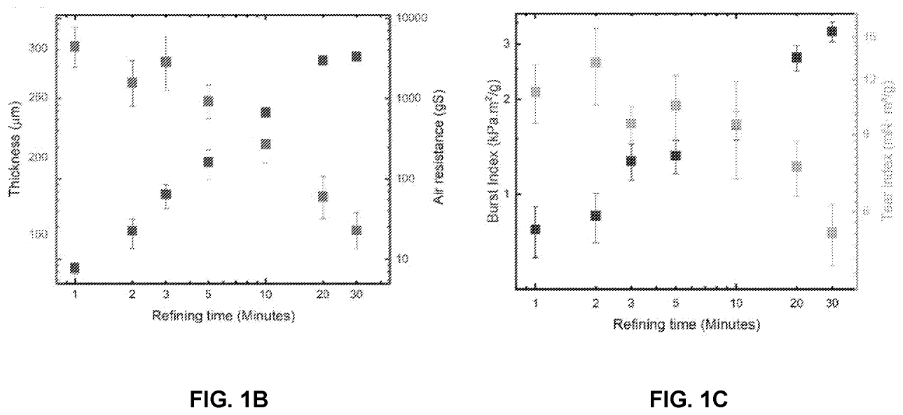

Effects of pulp refining on mechanical properties of handsheets: Pulp refining was done through mechanical beating without the use of any chemical additives, as the focus was to explore the inherent properties of the banana fiber. Its role is evident from digital images of the surfaces of hand sheets (FIG. 1A) prepared from pulp refined from zero to 30 minutes, revealing a transition from a rough to a smooth surface-paper. Further details on the characteristics of the paper as affected by mechanical refining of the pulp are displayed Table 1 together with FIG. 1. It is apparent from Table 1 that the freeness (drainage rate) of the pulp reduces substantially with increased refining, decreasing to one-fourth its value from 678 ml with no refining, to 185 ml with 30 minutes of refining. This trend is expected since fibers are shortened and become more fibrillated because of shearing and compression forces during refining thereby enhancing the available surface area for water holding and slowing drainage i.e., have lower CSF values. Fibrillation also results in generation of microscopically hairy appearances on the fibers because of delamination of the cell wall. Rise in the number of tiny hairs on the fiber surface leads to increased tendency to develop interfiber bonds resulting in a smoother finish and compact structure of the handsheets produced from more reined pulp (FIG. 1A). FIG. 1B reveals that the thickness of the handsheets decreases (almost linearly) with refining as the fibers collapse under high shear and compression during refining, resulting in the dense packing of fibers and fines in the resulting paper (Gharehkhani, S., et al. Carbohydr. Polym. 2015, pp 785-803); the paper thickness drops by half as we go from 0 to 30 minutes of refining time. A rise in the density of paper (Table 1) with refining is also a result of a more compact structure due to the consolidation of the fibers. One major outcome of the close packing of fibers is a smooth finish of the handsheets (FIG. 1A) because of a reduction in the free space between the fibers. Close packing also increases the air resistance of the paper (FIG. 1B, Table 1) by well over an order of magnitude. One should note that increased air resistance relates to lower porosity of paper, which can influence its usage as a release or sorption matrix.

Another significant outcome of pulp refining is the variation in burst and tear indices with increased refining of the fibers. FIG. 1C displays a rise in the burst index of the paper with more refining. This is understandable because increased fibrillation in more refined fibers would produce additional hydrogen bonds and a more compact structure of paper to resist any external pressure. Tear index, on the other hand, decreases with the rise in pulp refining. Since tear index is a measure of the force required to continue the tearing of paper in a specific direction, the presence of a higher number of scattered short fibers in more refined pulp can be a major reason for its decrease with refining.

TABLE 1
Comparative properties of handsheets prepared from banana fiber unrefined pulp (BP-
0), and pulp refined for 1 minute (BP-1), 2 minutes (BP-2), 3 minutes (BP-3), 5
minutes (BP-5), 10 minutes (BP-10), 20 minutes (BP-20) and 30 minutes (BP-30).

| Samples | BP-0 | BP-1 | BP-2 | BP-3 | BP-5 | BP-10 | BP-20 | BP-30 |
|---|---|---|---|---|---|---|---|---|
| Refining time | 0 | 1 | 2 | 3 | 5 | 10 | 20 | 30 |
| (minutes) | | | | | | | | |
| Freeness | 678 | 599 | 520 | 540 | 479 | 381 | 307 | 185 |
| (mls) | | | | | | | | |
| Density | 216.10 | 250.40 | 275.70 | 288.80 | 314.00 | 353.00 | 450.70 | 510.49 |
| (kG/m³) | | | | | | | | |
| Air resistance | 2.19 | 7.84 | 22.68 | 64.3 | 163.06 | 669.7 | 2977.06 | 3327.55 |
| (gs/100 ml) | | | | | | | | |
| Tear Index | 10.72 | 11.26 | 13.14 | 9.54 | 10.48 | 90.50 | 7.58 | 5.38 |
| (mN · m²/g) | | | | | | | | |
| Burst Index | 0.46 | 0.77 | 0.85 | 1.27 | 1.32 | 1.66 | 2.72 | 3.29 |
| (kPa · m²/g) | | | | | | | | |
| Tensile Index | 0.015 | 0.017 | 0.019 | 0.022 | 0.028 | 0.043 | 0.053 | 0.060 |
| (N · m/g) | | | | | | | | |
| % Root | 100 | — | 100 | — | 100 | 80 | — | 00 |
| penetration | | | | | | | | |

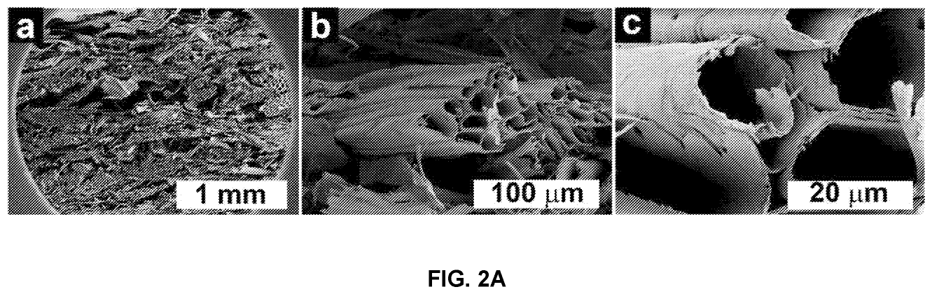

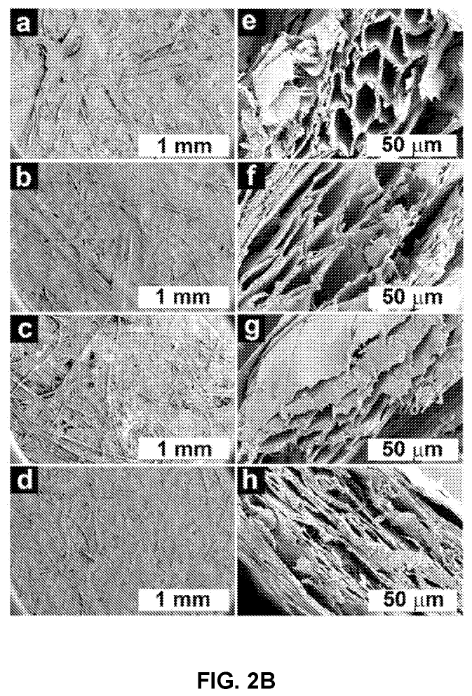

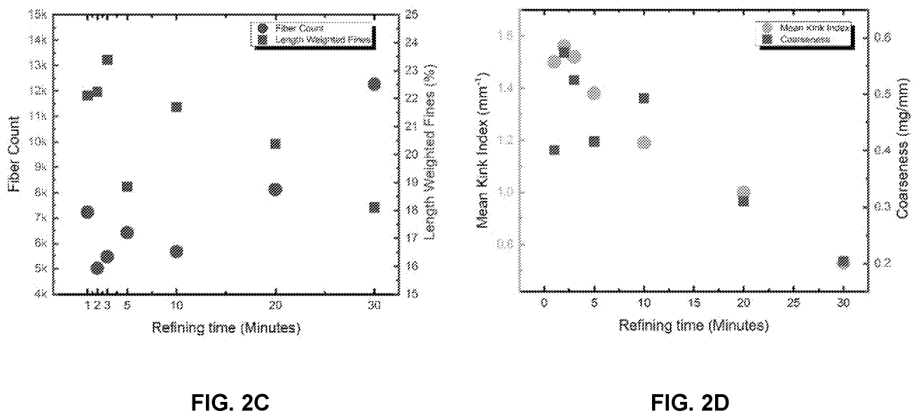

Effect of refining on fiber structure: Microstructural analysis of the banana fibers subjected to different conditions was used to better understand the physical property changes it shows with refining. As a first step, SEM images of the cross section of paper produced from unrefined banana fibers were examined (FIG. 2A). These images clearly show that the fibers consist of bundles of long tubular structures or microfibrils made up of an inner hollow region (lumen) with diameter in the range of 20 μm and a thin layer of about 1 μm between the cell walls known as middle lamella (Zuluaga, R., et al. Carbohydr. Polym. 2009, 76 (1), 51-59; Scott, W. E., et al. Properties of Paper: An Introduction. TAPPI Press: Atlanta, G A 1995, pp xviii, 191 p.). The long hollow lumens in banana fibers are responsible for high capillary action in the banana stem and play a major role in dictating the sorption properties of products made from banana fibers (Fanta, A., et al. In TAPPI 2014 PEERS Conference, Tacoma, Washington, Sep. 14-17, 2014; TAPPI Press: Peachtree Corners, G A, 2014; p 10.; Subagyo, A., et al. In Banana Nutrition-Function and Processing Kinetics [Online]; Jideani, A. I. O., Anyasi, T. A. IntechOpen, London, U K, 2018; Vol. 1, p 13; Mohapatra, D., et al. J. Sci. Ind. Res. (India). 2010, 69 (5), 323-329).

During refining, the fibers undergo considerable changes in their microstructure as is evident from FIGS. 1, 2B, 2C & 2D. The digital image in FIG. 1A and SEM micrographs of the surface sections in FIGS. 2B(a-d) and 7(A-C) show that the fiber structure got compact with longer refining times leading to a smoother surface with fewer loose fibers. The compaction is more evident in cross-sectional images which show the microfibrils to collapse and the lumens to lose their morphology with refining (FIGS. 2B(e-h) and 7(a-c)). These changes in microstructure are consistent with our results of paper getting thinner with refining time (FIG. 1B). A close examination of surface sections also supports the argument developed in the previous section that the fibrillation of the banana fiber has resulted in the production of a collapsed (flat) structure with possibly stronger bonds between each other. This can result in the generation of mechanically strong handsheets produced from pulp that has been refined for a longer time.

To analyze further the effects of refining on fiber structure, samples of pulp refined at various time-intervals were collected and analyzed for what is referred to as ‘fiber quality’, one measure of which is the quantity of fiber fines. Fines are the high surface area fibers generated during a typical mechanical pulping process and a high number of fiber fines in the pulp contributes towards formation of mechanically strong and less porous paper (Motamedian, H. R., et al. Cellulose 2019, 26 (6), 4099-4124; Giner Tovar, R., et al. BioResources 2015, 10 (4), 7242-7251). Fines are referred to as the fraction of pulp which passes through a 200-mesh screen of a fiber length classifier according to the TAPPI test method T 261 Cm-94 (Gharehkhani, S., et al. Carbohydr. Polym. 2015, pp 785-803; Motamedian, H. R., et al. Cellulose 2019, 26 (6), 4099-4124; Giner Tovar, R., et al. BioResources 2015, 10 (4), 7242-7251; Li, B., et al. Ind. Eng. Chem. Res. 2011, 50 (22), 12572-12578). Fines are further categorized into primary fines that are present during the pulping and bleaching process, and secondary fines that are generated as a result of refining (Gharehkhani, S., et al. Carbohydr. Polym. 2015, pp 785-803; Giner Tovar, R., et al. BioResources 2015, 10 (4), 7242-7251; Mayr, M., et al. Nord. Pulp Pap. Res. J. 2017, 32 (02), 244-252). Generally, refining of the fiber pulp generates secondary fines, increasing overall fine content in the pulp, which is shown as the rise in fiber count with increase in refining time in FIG. 2C. The change in percent length of fines, on the other hand, is inconsistent and stays almost in the same range (18-24%) when the pulp is refined from 1 to 10 minutes indicating larger distribution in fiber and fine size at low refining. Such unanticipated behavior has been previously reported for the pulps having fiber % content of less than 10% (Gharehkhani, S., et al. Carbohydr. Polym. 2015, pp 785-803; Wistara, N., et al. Cellulose 1999, 6 (4), 291-324). Considering the fact that the pulp content in the experiments was just 3%, inconsistent variation in fine content is totally understandable. However, when the pulp is refined for 20 and 30 minutes, there was a gradual decrease in the % length of the fines, which is understandable and supports the formation of more compact and less porous handsheets as displayed in FIG. 1A and Table 1

Two other interesting features of the fiber pulp which affect the properties of the paper are variation in mean kink index and fiber coarseness (FIG. 2D). While there is no regular trend displayed by pulp refined for smaller intervals, there was a clear decrease in fiber coarseness of the pulp refined for 10, 20 and 30 minutes. A reduction in fiber coarseness can be attributed to increased fibrillation and collapsing of the fibers with refining as supported by macroscopic (FIG. 1A) and microscopic (FIG. 2B) structure of the handsheets. While mean kink index is indicative of an abrupt change in fiber curvature, it is apparent from FIG. 2D that the kink index of the fibers is decreasing with refining time of the pulp. This makes sense because refining results in breaking the fibers into shorter sizes which can lead to straightening of the fibers, therefore helping in stacking the fibers close together to generate stronger paper with more smooth finish (Motamedian, H. R., et al. Cellulose 2019, 26 (6), 4099-4124). Reduction in the kink index is also considered an advantage to prepare mechanically strong paper since it improves the load carrying ability as well as stress distribution of the handsheets (Gärd, J. M. S. Thesis, Lulea University of Technology, Lulea, Sweden., 2002).

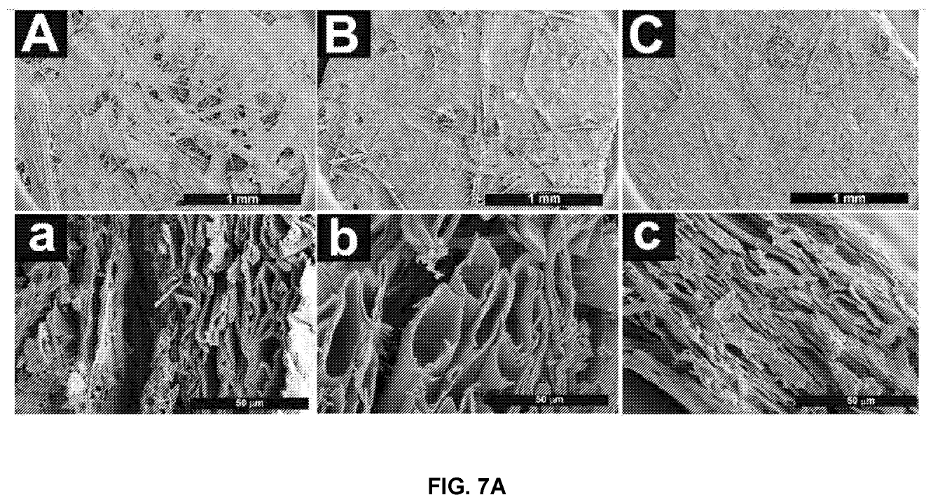

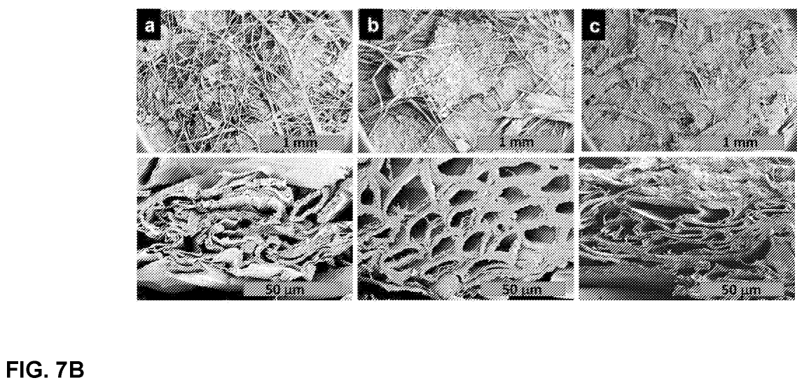

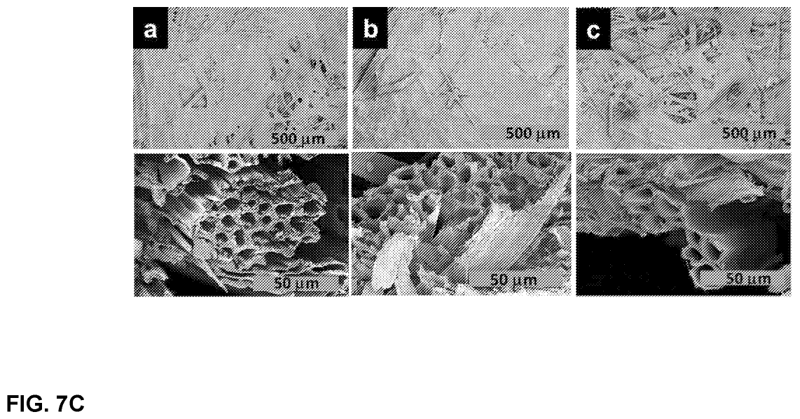

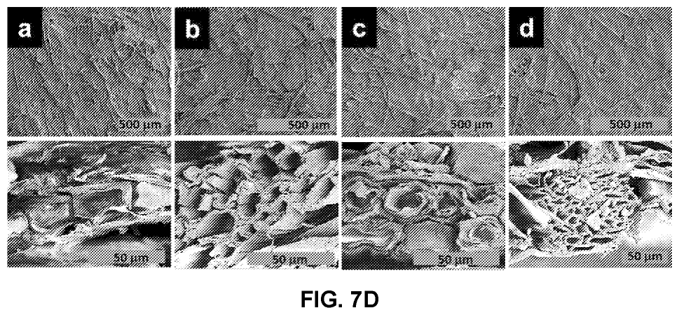

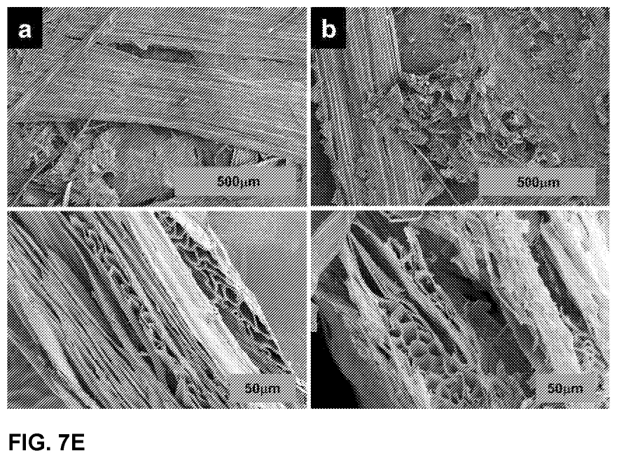

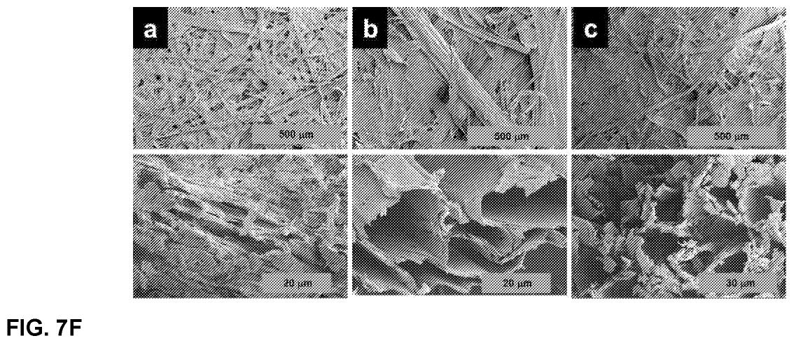

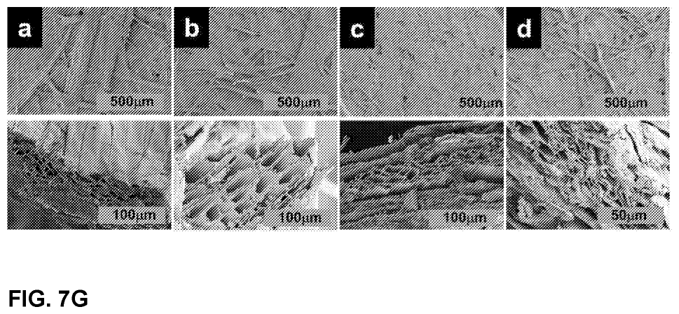

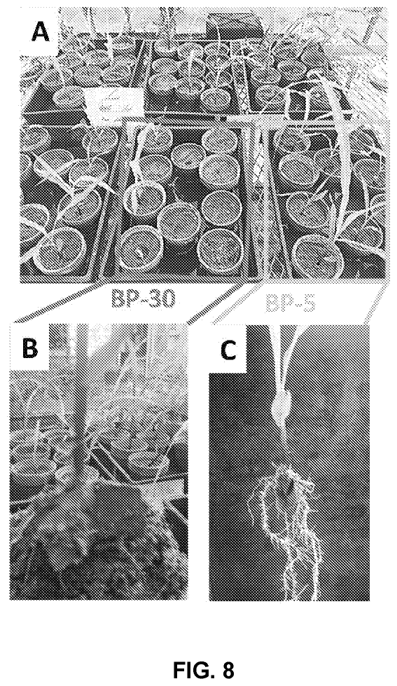

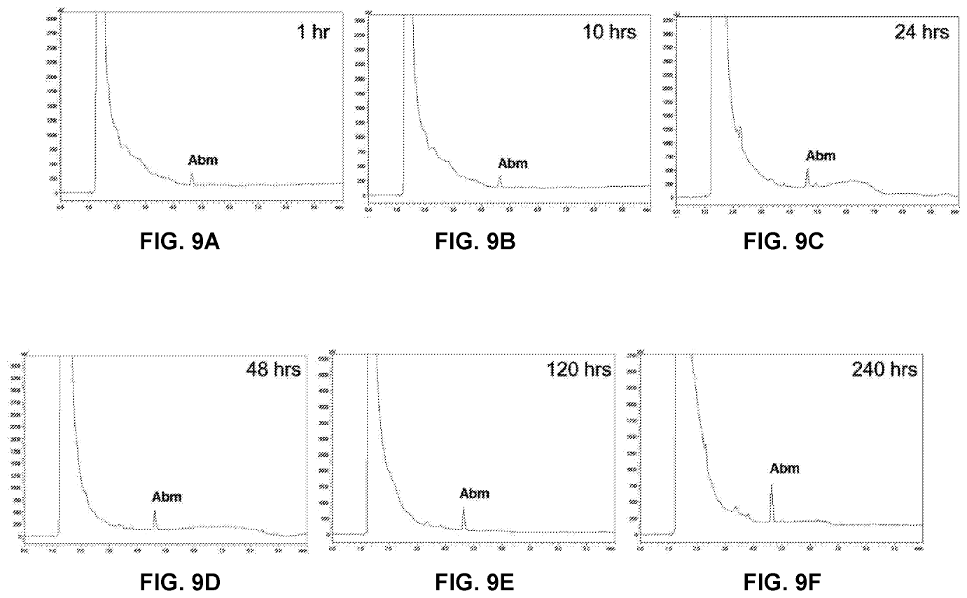

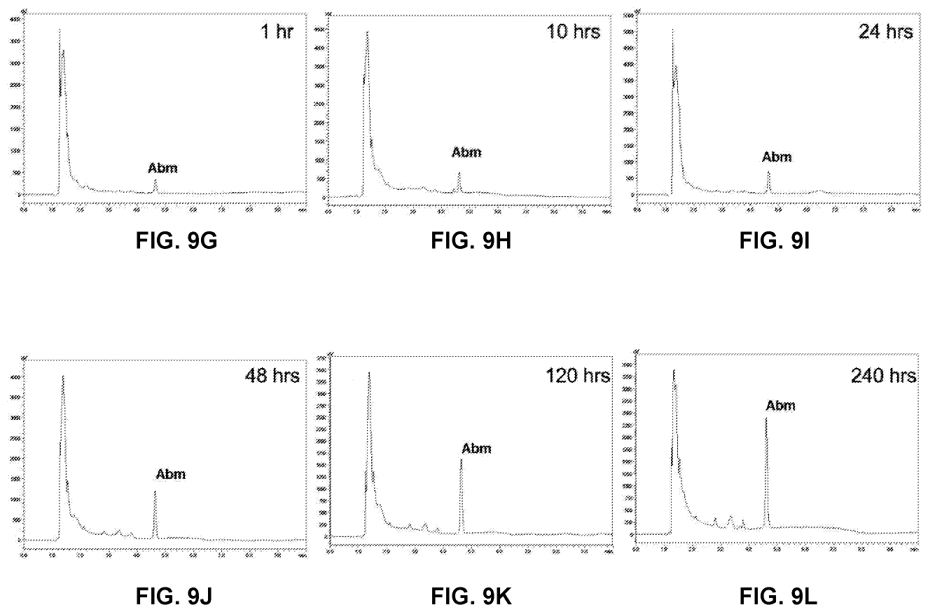

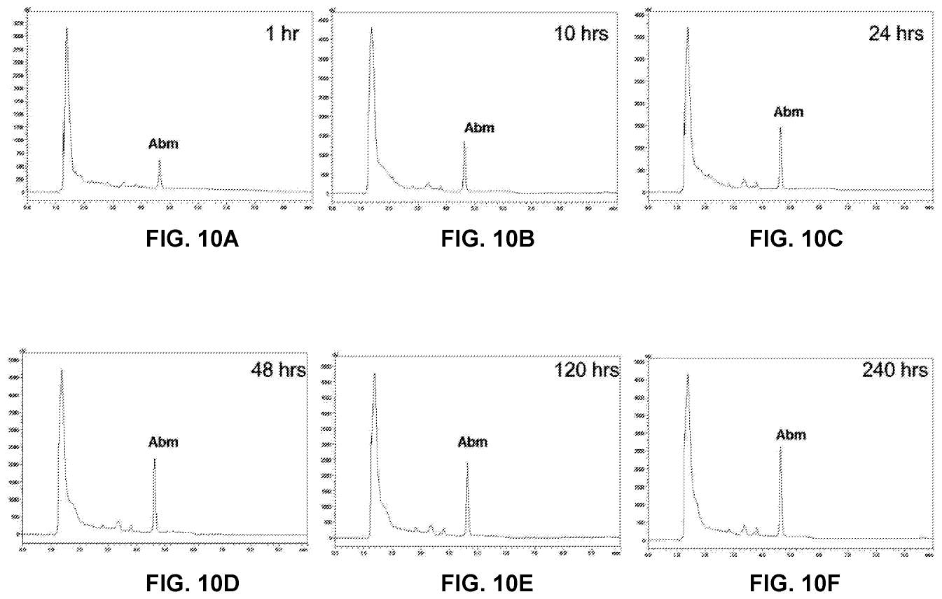

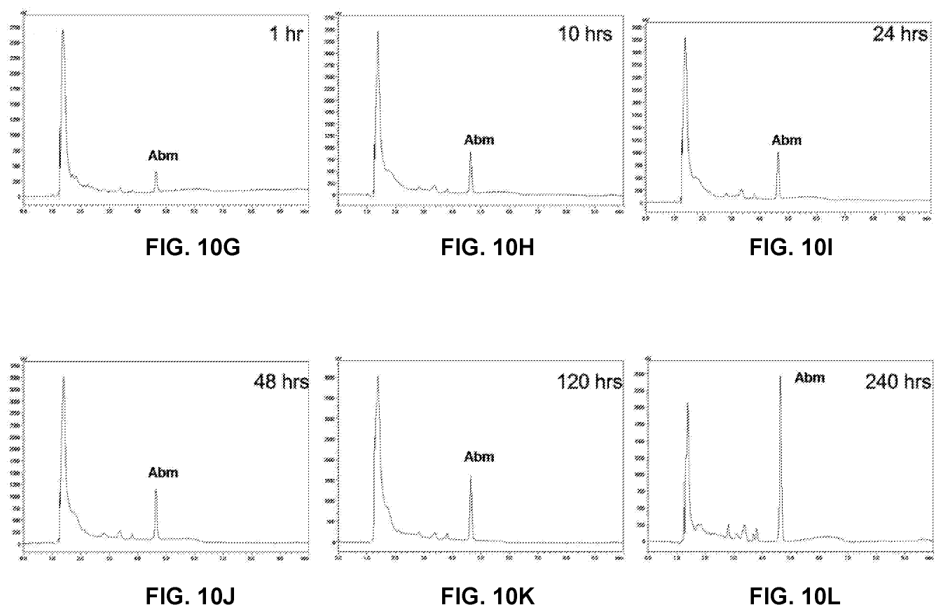

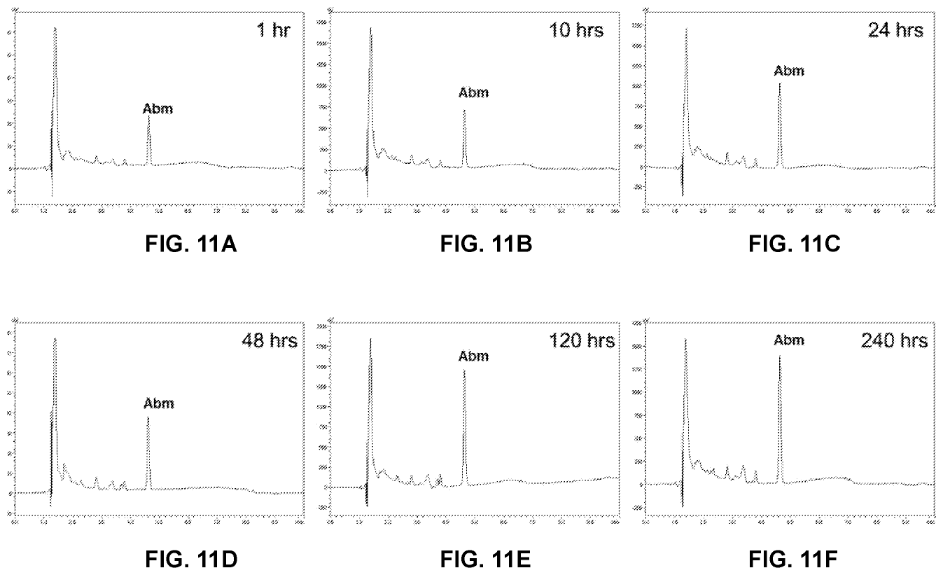

Root Penetration studies: The mechanical strength of the paper plays a critical role in designing an effective seed wrap loaded with active ingredients, e.g., pesticides or soil amendments. When wrapped around the seed/seedling, a strong paper could impede growth of the root after seed germination. A weak paper, on the other hand, would tend to disintegrate in the soil, before being able to unload its cargo. Since the burst and tensile indices of banana paper (FIG. 10 and Table 1) increase with refining; our challenge is to identify a threshold where the paper is strong enough to stay intact in the soil for the required time, while allowing the germinating roots to penetrate it. As displayed in Table 1 and FIG. 7A, root penetration studies conducted for 2 weeks demonstrate the highest penetration (100%) in the setup that used BP-0, BP-2 and BP-5 (paper produced from unrefined, 2-minute refined, and 5-minute refined pulp, respectively) as the seed wrap. We observed that BP-0, when removed from the soil, had already started to disintegrate, which was undoubtedly because of its low strength—a property that clearly makes it unsuitable as a seed wrap. While the seeds wrapped with papers produced from 10 minute refined pulp (BP-10) exhibit lower rates with a root penetration profile of 80%, the seed wraps prepared from BP-5 (paper produced from 5 minutes refined pulp) display an impressive root penetration profile (100% penetration through paper). When removed from soil, all the other papers produced from 2-, 5- and 10-minute refined pulp (BP-2, BP-5 and BP-10 respectively) were found almost intact while letting the germinating roots penetrate in each case. However, upon close examination of the papers, cracks were clearly visible on BP-2 and it was apparent that if kept in its present form, it would begin disintegrating within a week. BP-5, on the other hand, stayed as a single intact piece while the developing roots penetrated robustly (FIG. 7C)—a tendency which suggests that the strength of BP-5 is suitable to serve as an effective seed wrap. BP-30 (produced from 30 minutes refined pulp), on the other hand, is too strong for roots to penetrate through and exhibit no root penetration (Table 1). Emergence shown by a few seeds wrapped with BP-30 could be attributed to developing roots growing around the stiff paper without penetrating it (FIG. 7B).

RhB release studies: An ideal release matrix should be capable of liberating the loaded molecules steadily, i.e., neither too fast nor too slow. Banana paper exhibits remarkable capacity as a sorbent because of the extensive network of tube-like microfibrils, facilitating transport of various materials through the plant. Similar transport properties in the paper produced from the banana fibers can be exploited if special care is taken to retain its microfibrillar structure (Fanta, A., et al. In TAPPI 2014 PEERS Conference, Tacoma, Washington, Sep. 14-17, 2014; TAPPI Press: Peachtree Corners, G A, 2014; p 10). Another parameter to examine for release of cargo is the lignocellulose composition of paper, particularly lignin content. The rationale behind studying release profiles of paper containing different amounts of lignin is that the presence of diverse functional groups in lignin may help to bind any exogenously applied molecule through chemical or physical bonds (Cao, J., et al. Cellulose 2016, 23 (1), 673-687). It has also been suggested that hydrophobic interactions between lignin and Abm result in the controlled release of Abm (Cao, J., et al. Cellulose 2016, 23 (1), 673-687).

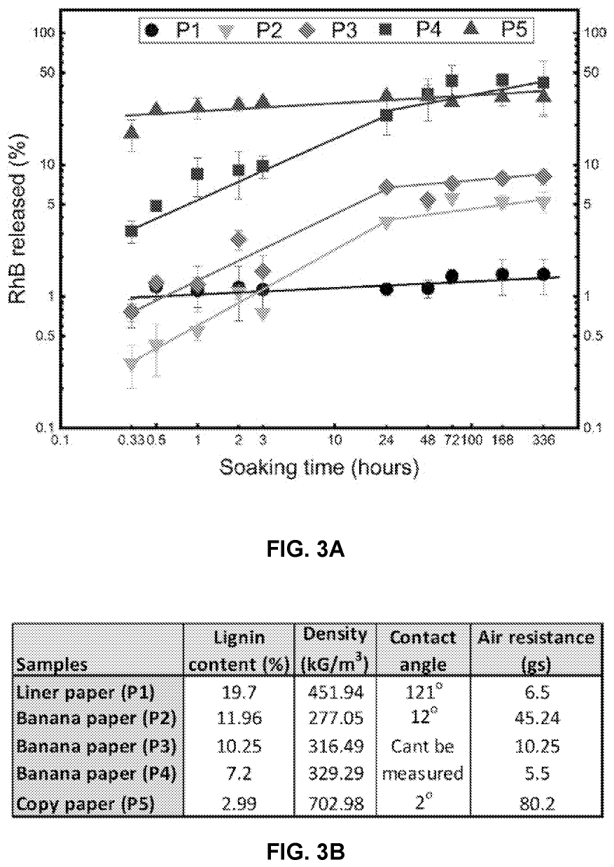

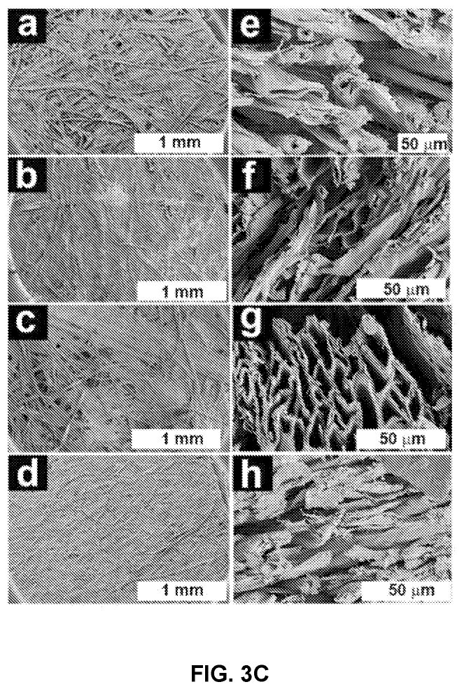

FIG. 3A shows the release profile of RhB from banana papers with different lignin content along with liner and copy paper, the latter two having the lowest and highest lignin content, while Table 2 shows total amount of % RhB released by each sample after 14 days (336 hrs). RhB was used as a model molecule to verify the possibility of interactions between lignin and a hydrophilic substance. Based on observation regarding the optimum strength profile of BP-5, paper produced from 5-minute refined pulp was selected from different sources of banana fibers (P2, P3 & P4) having different lignin content and morphology as compared with two controls, i.e., non-banana papers containing high lignin (P1-liner paper) and very low lignin content (P5-copy paper). Lignin content was estimated as 19.7, 11.96, 10.25, 5.09 and 2.99 in P1 (non-banana liner), P2, P3, P4 (banana papers) and P5 (non-banana copy paper), respectively (FIG. 3B).

FIG. 3A reveals that all three types of banana papers exhibit similar trends in releasing RhB, which can be easily distinguished into two steps. The first step demonstrates fast release kinetics of the dye molecules from the paper within first 24 hours of the study. The second step shows a comparatively slower release from all the banana paper. The initial fast release can be attributed to the detachment of dye molecules which were stacked on the surface of paper, probably through weak physical bonds. The slow release in the second step likely represents movement of dye molecules, which were strongly bonded either on the surface or deeper in the bulk. Irrespective of the similar trend in release profiles of all banana papers, it is also apparent in FIG. 3A that the lignin content of paper plays a key role in determining its release profile i.e., faster release with low lignin content. Both the controls also follow similar lignin-dependent release trends, however displaying a single step release profile.

FIG. 3A also shows that RhB release from the high lignin paper (P1) is very slow as compared to the amount sorbed, while the low lignin paper (P5) displays a fast release of the dye molecules. Based on these observations, one can surmise that the availability of multiple binding sites in lignin-is capable of developing strong interactions with the hydrophilic dye molecules. While presence of similar functional groups between RhB and the cellulose component of banana fiber rules out any possibility of strong bonds between cellulose and RhB, strength of interactions between various matrices and RhB can be mainly attributed to their lignin content. Recently, lignin based materials have been utilized by various research groups as sorbents for RhB contaminants and there is clear evidence of electrostatic interactions between oppositely charged functional groups of lignin and RhB (Li, Y., et al. Chem. Eng. 2016, 4 (10), 5523-5532; Chen, F., et al. React. Funct. Polym. 2019, 143, 104336). Lignin is a complex molecule, mainly hydrophobic in nature, with many functional groups such as hydroxyl, phenolic, carboxyl, carbonyl, methyl and ether, that can easily develop strong interactions with the carboxylic group of incoming dye molecules. Furthermore, the strength of the bonds between dye and the paper seems to be dependent on the total lignin content of the paper, which determines its release profile, i.e., low amount of lignin resulting in fewer interactions between the dye and lignin, therefore, leading to fast release of the dye and vice versa.

Another factor that can play a role in deciding the sorption/release profile of paper is the variation in the morphology of the fibrous network of each type of paper. FIG. 3B depicts the lignin content, density and air resistance (inversely related to porosity) of P1, P3, P4, and P5 while FIG. 3C displays the difference in morphology of the samples (surface and cross-section morphology of P2 is already shown in FIG. 3B (b & 2f). It appears that low lignin content paper (P5) consists of fibers with a compact structure and low porosity, which might have led to the inability of the dye molecules to migrate deeper into the paper and, therefore, release quickly when soaked in the release medium. This observation taken together with a lack of the two-step release profile of P5 (FIG. 4A) indicates that fiber morphology of the release matrix also determines its capability to the release of the cargo. For instance, the high lignin paper (P1) exhibits almost similar porosity and loose fibrous networks on the surface as P4 (banana paper) (FIGS. 4B & 4C(a & c)). However, the respective cross sections of P1 and P4 in FIG. 4C(e & g) exhibit a combination of compressed and intact microfibrils consisting of smaller diameter lumens with very thick walls in P1, which is in contrast to the well-organized and undamaged microfibrillar structure consisting of large sized lumens observed in P4. Interestingly, P4 (lignin content=7.2%) displays a continuous rise in RhB release, exceeding that of P5 (lignin content of 2.99%) after 48 hours. This trend can be attributed to highly porous nature of P4 as compared to P5 i.e., low air resistance of P4 is indicative of its highly porosity (FIG. 3(B)). Presence of larger number of pores in P4, results in gradual release of loosely bound dye molecules even from the bulk while less porous P5 is unable to release all the dye molecules after 48 hours of release studies. Furthermore, a very high water contact angle (WCA) of P1(120°) represents its highly hydrophobic nature, which might have played a role in determining its release profile in an aqueous medium, as compared to hydrophilic nature of P2)(WCA:12°, P4)(WCA:2°, P2 and P3 (WCA couldn't be measured). Therefore, it seems that a balance between the lignin content and fiber morphology is critical for governing its release profile. Variation of the rate of release of loaded molecules from paper, depending on their lignin content, porosity, and morphology, can play a vital role in designing the seed wrap for slow or burst release of the loaded cargo, depending on the nature of the crop and edaphic environment.

Abm release from various matrices: Regardless of how the release studies of hydrophilic RhB provide a convincing picture for banana paper compared to control papers, similar trends cannot be predicted for a hydrophobic molecule, such as Abm that can be used in real applications. To demonstrate efficacy of paper as a controlled release medium for pesticides, we analyzed release of Abm from all the samples utilized in the dye release study. It is apparent from FIG. 4A and Table 2 that there is an increase in the release of Abm with decreasing lignin content in paper; however, after a comparatively faster initial release of Abm, the low lignin content banana paper (P4) releases almost the same amount of Abm (24.33±2.04%) as do the remaining banana papers (P2 and P3) at the end of two-week long study. This result indicates that the release profile of banana paper is not solely regulated by its lignin content and there are other unique features to which its sorption/release properties can be attributed to. The low lignin content non-banana paper (P5), on the other hand, releases a comparatively larger amount of Abm (71.26±8.98%) than RhB (37.47±8.51%) within the same period, which indicates its weaker ability to bind Abm molecules. Interestingly, the high lignin non-banana paper (P1) displays a release profile, similar to the release profiles of P2, P3 and P4. The difference in the release profile of P1 while loaded with Abm compared to RhB can be attributed to the strong hydrophobic interactions between the lignin and Abm molecules, resulting in an initial faster desorption of the surface sorbed molecules and slow release of the molecules sorbed into the bulk. However, it is notable that the rate of release of Abm from P1, P2, P3 and P4 in the first step is much slower than the release rate of RhB (FIG. 3A), which can be mainly attributed to the comparatively strong intermolecular interactions between hydrophobic Abm and paper.

TABLE 2
Average thickness of individual disks, average value with standard
deviation of total % rhodamine B (RhB) released, % abamectin (Abm)
released and % of bioavailable of Abm from P1, P2, P3, P4 and P5

| | Thickness | % RhB | % Abm | % Abm |
|---|---|---|---|---|
| Samples | (μm) | released | released | bioavailability |
| Liner paper (P1) | 435 | 1.47 ± 0.44 | 9.85 ± 0.95 | 55 ± 3.95 |
| Banana paper (P2) | 309.7 | 5.25 ± 0.91 | 20.44 ± 1.23 | 87 ± 2.89 |
| Banana paper (P3) | 415.6 | 8.14 ± 1.09 | 23.11 ± 1.32 | 82 ± 7.64 |
| Banana paper (P4) | 288.6 | 42.08 ± 18.86 | 24.33 ± 2.04 | 77 ± 2.64 |
| Copy paper (P5) | 118.6 | 37.47 ± 8.51 | 71.26 ± 8.98 | 100 ± 2.67 |

Bioavailability of Abm loaded matrices: To estimate how much Abm would be biologically available to the target pests, in-vitro studies were conducted using C. elegans as model nematodes following the procedure displayed in FIG. 4B. While none of the banana or non-banana fiber-based matrices displayed any nematicidal activity without being loaded Abm, it is apparent from FIG. 4C that despite variation in lignin content, all the banana fiber matrices exhibited similar release profiles. Conversely, P1 (high lignin non-banana paper) displayed a slow release, in contrast to P5 (low lignin non-banana paper), which exhibited a burst release with about 85% of the nematodes becoming inactive during the first hour of Abm exposure. The Abm bioavailability exhibited by P1 and P5 was quite similar to their respective RhB and Abm release profiles, and taken alone seems to be consistent with the hypothesis that lignin alone dictates release of active ingredients (Cao, J., et al. Cellulose 2016, 23 (1), 673-687). As such, the high lignin content in P1 would cause strong binding of Abm, making it unavailable to affect the nematodes. On the other hand, weaker interactions developed between Abm and low lignin containing paper (P5) result in burst release, causing immobilization of almost all the nematodes within the first hour of exposure. However, the similar release profiles of Abm exhibited by all the banana papers, despite difference in their lignin content, does not seem to support the previous hypotheses regarding the solitary role of lignin in regulating release profiles of the lignocellulosic materials developed from banana fibers (Cao, J., et al. Cellulose 2016, 23 (1), 673-687). The extraordinary hierarchical microfibrillar morphology of banana fiber in the matrix may therefore be responsible for its release characteristics. The ‘wrap and plant’ banana paper matrix with its ‘dual knob’ tunable functionality thus presents itself as excellent candidate for controlled release of loaded cargos for cost-effective and enhanced crop protection in nutrient depleted and pest infested soils.

Conclusion

A sustainable wrap-and-plant approach is described that uses wastes of banana harvests as tunable release medium through a cost-effective and chemical-free conversion method. Since the biodegradable nature of this matrix can be exploited in fabricating controlled-release matrices for crop protection, a unique approach is proposed that can be beneficial in fine tuning the properties of banana fibers as seed/seedling wrap. The effects of pulp on various properties of lignocellulosic matrices produced from banana fibers was systematically investigated. Increased refining of the pulp resulted in reduction in freeness, fiber coarseness, and mean kink index, and therefore contributed to the production of robust matrices because of fibrillation and the strong bonding of fibers. Using rhodamine B (RhB) and abamectin (Abm) as model molecules, comparative release properties of three different types of matrices developed from banana fibers were studied against two matrices developed from non-banana fibers as controls. Interestingly, all the banana fiber-based matrices exhibited similar trends in dye release, which were different from the release profiles of the controls. These studies indicate that lignin content of the matrix plays a major role in determining its release profiles because the loaded molecules are released slowly from a high lignin content matrix while a burst release of the dye is observed from a low lignin content matrix. However, the differences in the fibrillar morphology of the matrices seem to also play critical roles in tuning their respective release profiles. To further understand their effectiveness as controlled release media for the pesticides, the release profile of Abm loaded matrices was studied via HPLC followed by in-vitro bio-assays. These studies demonstrate a lignin content dependent release profile for the non-banana fiber samples. However, all the banana fiber-based matrices exhibit almost similar profiles of Abm bioavailability, regardless of variation in lignin content in individual test matrices. This finding indicates the significant role played by fiber processing and morphology in tuning the unique properties of banana fiber-based matrix as a controlled release medium. By making use of this wrap-and-plant approach, one can design biodegradable seed wraps with tunable strength, soil integrity, and release properties.

### Example 2: Efficacy of Banana Paper Treated with Abamectin for Nematode Management on Yam (Dioscorea Spp.) in Guinea-Sudan Transition Zone of Benin, West Africa

### Introduction

Increasing quantity and quality of food and fiber crops worldwide is a significant challenge (Amundsen et al. 2015,) in the face of changing climate, increased urbanization, and reductions in arable land for food production. Vagaries in rainfall associated climate change drive the dynamics of land use patterns that may negatively impact agricultural production. Increased urbanization and reductions in arable land for food production stress existing social organization and agroecosysems. The need for improvements in crop production and quality is especially acute in Sub-Saharan Africa (Coyne et al. 2018, Coyne and Affokpon 2018). Food security and safety for an expanding population in much of Africa and other underdeveloped parts of the world is essential. Greater yield and more stable production on existing land through sustainable crop management can also improve quality, stability, and storage capacity of food systems (Barker and Koenning, 1998, Bridge, 1996, Coyne et al. 2018). All components of food safety and security can benefit from the implementation of better pest management techniques. An important, yet often neglected, constraint to production of all crops are the losses in yield potential that can be attributed to plant-parasitic nematodes (Sasser and Freckman, 1987).

Yam Dioscorea rotundata and D. alata is an important staple in the African diet and is a major crop for smallholder farmers in West Africa (Affokpon et al. 2017, Alexander 1969, Coyne and Affokpon 2018, Coyne et al. 2018), Yam is the 4^{th} largest tuber crop in the world after potato and a major component of west African diets (Coyne and Affokpon 2018). Nigeria, Benin, Ghana, Ivory Coast, Cameroon, and Togo produce over 67 million mt with the majority in Nigeria (FAO Stats). The humid savanna agroecosystem (Jagtap, 1995) located in this part of Africa accounts for most world yam production, primarily on ferruginous soils with a sandy loam texture. More than 50% of the crop is lost to plant-parasitic nematodes (PPN) in extreme cases, though an annual loss of about 17% is more typical (Adesiyan, 1975, Affokpon et al. 2015, Coyne et al. 2018, Sasser and Freckman, 1987). A lack of training in agronomics and pest management techniques is a further obstacle to yield improvement in much of Africa (Coyne et. al. 2018). Management of yam nematodes in Africa is also difficult because of the remote location of small-holder farms, lack of distribution systems for inputs, and a limited capacity for information transfer (Coyne et. al. 2018). The lack of available and or affordable nematode control options thus presents a major obstacle to increased productivity for this crop (Adeslyan et al. 1975, Coyne et al. 2018).

Often the solution to greater crop production has been to load agroecosystems with chemical inputs to improve yield (Barker and Koenning 1998, Dalin and Outhwaite 2019, Fraser and Campbell 2019). A unique, simple, and inexpensive technique (Wrap and Plant technique) for protection of yam tubers from damage caused by plant-parasitic nematodes was developed and evaluated on smallholder farms in Benin (Affokpon et al. 2015A Cao et al. 2016, Opperman et al. 2018, Prizada et al. 2020).

The Root-knot, cyst, and reniform nematodes are likely the most damaging nematode plant-parasites worldwide (Sasser and Freckman 1985), however numerous other species cause plant damage that is both insidious and often ascribed to other causes. The most important yam plant-parasites are the root-knot nematodes (Meloidogyne spp.) and the yam spiral nematode Scutellonema bradys, though Pratylenchus spp. are also commonly associated with yam (Affokpon et al. 2017; Atu, and Ogbuji 1986; Coyne and Affokpon 2018; Coyne et al. 2006). The yam nematode S. bradys, is likely the single most important parasite due to it ubiquitous presence in yam plantings (Affokpon et al. 2017). Because S. bradys is a migratory endoparasite (resides in the roots and tubers, as well as soil) of yam, it has been transported regionally with yam seed pieces (Adyesian, S. O. 1977; Coyne et al. 2006).

Yam nematode, S. bradys residing in yam tubers during storage reduce their val ue since their respiration and reproduction in yam tubers during storage reduce tuber weight (Bridge 1996). The continued reproduction of yam nematode in stored yam and seed yams contributes the nematode population density at planting since yam seed piece stock comes from infested, stored tubers (Adyesian, 1977′ Coyne et al. 2006′ Coyne and Affokpon 2018). Typically, pre-plant density of plant parasitic nematodes is negatively correlated with crop yield. In the yam-Scutellonema pathosystem initial nematode density is composed of nematodes on seed pieces and nematodes in the soil at planting. Yam nematode present on the seed piece at planting is an important constraint to yam productivity though the role of nematode density in soil has not been well studied. Soil population density is the result of the previous crops and the suitability of the particular soil present for nematode activity such as movement and host penetration. Hot water or nematicide treatment of yam seed pieces improve early yam growth and yield indicating that seed piece density of nematodes is of primary importance (Adesiyan and Badra 1982; Badra and Caveness 1979; Bridge 1975; Cadet and Daly 1996; Kenyon et al. 2005).

Conventional application of nematicides are not an option for this crop production system for management of plant-parasitic nematodes. One obvious drawback to chemical nematicides is their cost and the need for specialized application equipment. Most nematicides are acutely toxic to vertebrate species and thus dangerous for use by untrained farmers who also lack personal protective equipment (Goulson, 2020). Another drawback of nematicides is their high mammalian toxicity that may lead to their miss use, the nematicide carbofuran is used by poachers to intentionally poison wildlife in Africa (Goulson 2020; Ogada 2014). The carbamate nematicides, such as carbofuran and aldicarb also pose a risk due to their potential to contaminate ground water (Goulson, 2020).

In contrast to chemical nematicides, the nematicide abamectin, a mixture of ivermectins produced by the actinomycete Streptomyces avertimitilis, has low mammalian toxicity and few non-target effects (Khalil and Darwesh 2017). Abamectin as a biological product breaks down rapidly, binds to soil particles, and has low solubility which limits off site movement. Abamectin is not systemic in the plant, like many pesticides, thus pesticide residues are not an issue.

Field research was initiated in Benin in 2015 to evaluate the use of the disclosed “Wrap and Plant” (W&P) methodology for crop protection from plant parasitic nematodes. Wrapping yam seed pieces with abamectin treated banana paper at planting allows for an effective, simple, safe and economical nematode management option for subsistence farmers.

The incorporation of active pesticide ingredients or biological agents into a lignocellulose matrix, such as banana paper (Pappu et al. 2015) enables effective distribution of crop protection agents without interfering in smallholder farming practices. The multi-year replicated field trial results demonstrate the efficacy and affordability of “W&P” technology for management of plant-parasitic nematodes on yam and white potato crops. On-farm field trials were conducted in 3 yam-growing agro-ecological zones in Benin from 2015-18. Tuber yield and quality were consistently and substantially greater than conventional farmers' practices across on-farm sites each year. Yield increases of up to 15% were observed with significant improvements in yam quality as well as an 80% reduction in final yam nematode (Scutellonema bradys) population density in tuber peels. Improved higher tuber quality and reduced nematode density in tuber peels provides for reduced risks of post-harvest tuber damage and loss due to this nematode. Finally, yam seed pieces from a previously treated crop should provide for increased yield in the subsequent year.

Specific objectives of this research were to: 1) evaluate the Wrap and plant technique on yield and quality of yam tubers in different regions of Benin, 2) demonstrate to subsistence farmers the utility of the technique, and 3) determine the feasibility and likelihood of farmer adoption of this practice.

Methods

Experimental sites: The study was undertaken from 2015 to 2018 in Guinea-Sudan transition zone of Benin (Centre of Benin, West Africa) in three districts: Glazoué (site of Houin), Savalou (site of Agbadogo) and Save (site of Gabe). The experiments were carried out for three consecutive years in a total of 26 farmers' fields at Glazoué, Savè, and Gobé and for two consecutive years at Savalou. The climate is tropical Guinea-Sudan humid savanah with a transitional regime between a bimodal rainfall distribution (Southern Benin) and unimodal rainfall distribution (Northern Benin). The average annual rainfall is between 900 and 1200 mm with seasonal variations and unequal distribution. Most of the soils in this region are classified as tropical ferruginous soils (Dubroeucq, 1977) with a sandy loam texture. The sites of Agbadogo and Gobé are located on lowland (fairly drained soils) while Houin is located on a plateau (well drained soils).

Planting material and nematode control products: Seed yams of “Klatchi” a locally popular cultivar of the complex Dioscorea cayenensis-rotundata were used in the three districts. Nematode control products assessed in this study were banana fiber paper (hereafter referred as banana paper) impregnated with or without micro-doses of abamectin. The banana paper was produced at the Forest Biomaterials Department, North Carolina State University, Raleigh, NC, USA, by additive-free, mechanical processing of banana fibers. The process of abamectin impregnation into banana fiber has been described (Pirzada et al. 2020). Abamectin was applied to sheets of banana paper sprayed with a solution containing 1 ppm abamectin and sheets were then cut into rectangles 10×20 cm, and holes drilled in the paper. Each sheet of paper contained 10 μg of abamectin. This resulted in plots with abamectin at the rate of 1.0 g/ha or 4.54 ppb.

Field experiment details: The fields were cleared of vegetation and mounds were made following traditional yam cultivation practice. Individual plots accommodated four rows of six mounds spaced at 1.20×1.20 m. Plots were arranged in a randomized complete block design with five replications and three treatments: 1) seed pieces wrapped in banana paper treated with abamectin at the rate of 1 ppm [PA], 2) banana paper alone [PO], and 3) untreated control (referred to as farmer practice [FP]). Each mound was planted with a single seed yam wrapped or not with banana paper depending on the treatment. No fertilizers were applied and planting and other cultural operations were done by farmers according to local practices. Planting occurred at the beginning of the first rainy seasons (late April-early May) and tubers were harvested 7-8 months later when vines were completely dried.

Tuber yields at Harvest and weight loss after 3 months storage: Tubers were harvested and yields determined as the cumulative weights from all mounds and expressed as g/m². The effect of the W&P on tuber storability was also assessed after a 3-month storage period. Weights of two tubers per plot used for post-harvest study were recorded before and after 3-month storage and the percentage weight loss was calculated as follows: (Mean weight of yam tubers at harvest—Mean weight of yam tubers after 3-months storage)×100)/Mean weight of yam tubers at harvest. The extent to which the wrap & plant technology would be appropriated by various end-users has been also investigated at harvest. Data related to this study were published separately.

Post-harvest experiment details: Evaluation of post-harvest efficacy of plant and wrap technology was initiated in 2016 to study the effect of treatments on nematode population increase, yam tuber weight decline, and quality after three months in storage. Tubers (2) were sampled from each plot and stored in a covered, open sided yam barn.

Assessment of nematode population dynamics: Prior to planting and at harvest, soil samples were collected from the middle mounds at 5 to 30 cm depth per plot using a hand trowel to determine initial population density of plant-parasitic nematodes (Pi). Soil cores from the same plot were combined, mixed thoroughly and a 250 ml composite sample was removed for nematode extraction using centrifugation technique. Final nematode population density (Pf) were estimated from tuber and soil at yam harvest. Soil from the middle mounds was sampled from the root zone and mixed in a bucket to obtain a composite soil sample of 250 cm³ soil. Final population density (Pf) of S. bradys was obtained by removing peels from four sides of three tubers at harvest using a kitchen vegetable peeler. Tuber peels from the same plot were mixed and 25 g sub-sample removed for nematode extraction. Nematodes in stored tubers were extracted from 25 g of yam peels following the procedure described earlier. Changes in S. bradys numbers were determined at yam harvest (Pi) and at 3 months after harvest (Pf). The reproductive factor (Rf) for S. bradys during storage was calculated as Rf=Pf/Pi. Only results on final S. bradys population density (Pf) per gram of peel are reported. Data on root-knot and other parasitic nematodes were not presented in this paper due to their low and inconsistent values even within fields.

Visual assessment of nematode damage: Before nematode extraction from tuber peels at harvest and after three months storage, tubers were assessed for dry rot severity using a scale of 1-5 where: 1=clean tuber; 2=1-25% of tuber skin symptoms (low level of damage) 3=25-50% of tuber skin symptoms (low to moderate level of damage); 4=51-75% moderate to severe level of damage); and (5) 76-100% tuber skin symptoms (high level of damage). Galling (the sign of root-knot nematode damage) is not reported as it was inconsistent and low, nor was cracking as this is largely a result of dry conditions during tuber development.

Data analyses: Data analysis for each site consisted of Analysis of Variance (ANOVA) for a randomized complete block design with three treatments and five replications. Combined analysis was done as for a factorial design with three treatments, five replications, 26 farms, and four years. All data analysis was accomplished using the General linear models procedure (PROC GLM) of PC/SAS software (SAS Institute, Cary, NC). The least significant difference (lsd, α=0.01 or 0.05) was used for mean separation. Since first and second order interactions with year, farm and treatment were significant (P≤0.01) (Table 3) each year and data between farms within year was analyzed separately to determine possible explanations for the variation. Analysis of covariance was also used to explain interactions.

TABLE 3
Analysis of variance (ANOVA) for yam yield (kg/M2, dry
rot (scale 1-5), and final population density of Scutellonema bradys
per gram of yam peel from 2015 to 2016.

| | | Yield mt/ha | | dry rot (1-5) | | Scutello Pf | |
|---|---|---|---|---|---|---|---|
| Source | DF | F Value | Pr > F | F Value | Pr > F | F Value | Pr > F |
| rep | 4 | 6.92 | <.0001 | 0.17 | 0.9522 | 1.4 | 0.2338 |
| trt | 2 | 142.56 | <.0001 | 157.21 | <.0001 | 1771.19 | <.0001 |
| farm | 17 | 45 | <.0001 | 13.44 | <.0001 | 100.7 | <.0001 |
| Year | 3 | 104.03 | <.0001 | 56.97 | <.0001 | 347.65 | <.0001 |
| farm*Year | 7 | 18.05 | <.0001 | 3.48 | 0.0013 | 68.99 | <.0001 |
| trt*farm | 34 | 2.15 | 0.0003 | 5.23 | <.0001 | 25.85 | <.0001 |
| trt*Year | 6 | 10.61 | <.0001 | 31.08 | <.0001 | 49.18 | <.0001 |
| trt*farm*Year | 14 | 2.01 | 0.0166 | 1.61 | 0.0752 | 22.36 | <.0001 |

Results

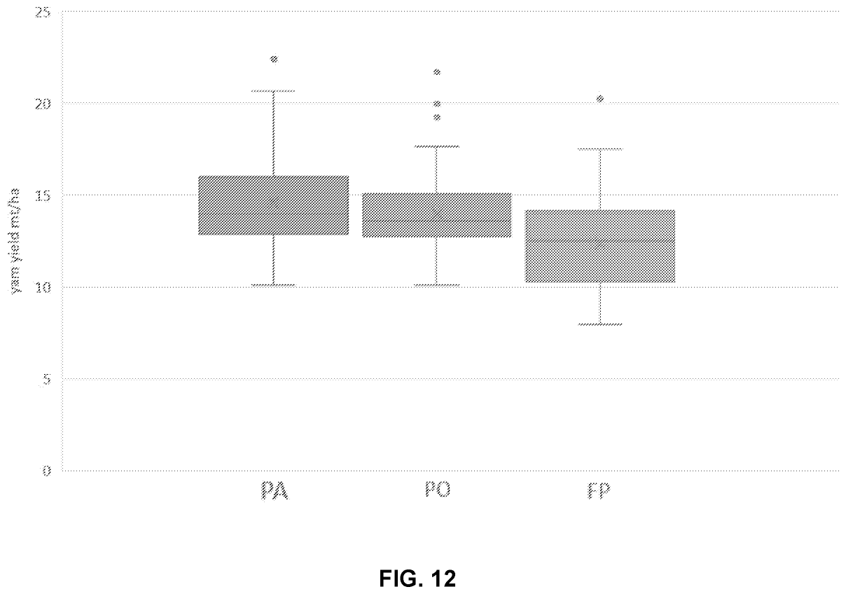

Yam yield and quality (dry rot): Yam yields were increased all years (P≤0.01) by treatments that included paper wrapped around individual seed tubers compared to farmer practice. Both treated and untreated paper treatments resulted in yield increases over controls (farmer practice), but paper treatments, treated paper vs. non-treated paper, often did not significantly differ from each other (FIG. 11). Though abamectin treated paper was generally superior to untreated paper, the difference between the two paper treatments were often indistinguishable from one another, suggesting that the banana paper alone provided a distinct advantage over farmer practice. Dry rot was greater (P≤0.01) in farmer practice (FP) treatments than either paper treatment (FIG. 12) and treated paper was superior to untreated paper.

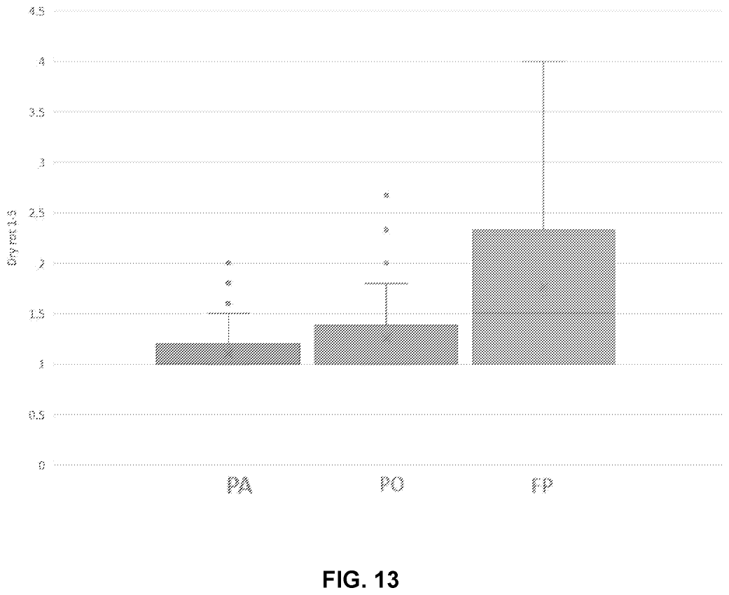

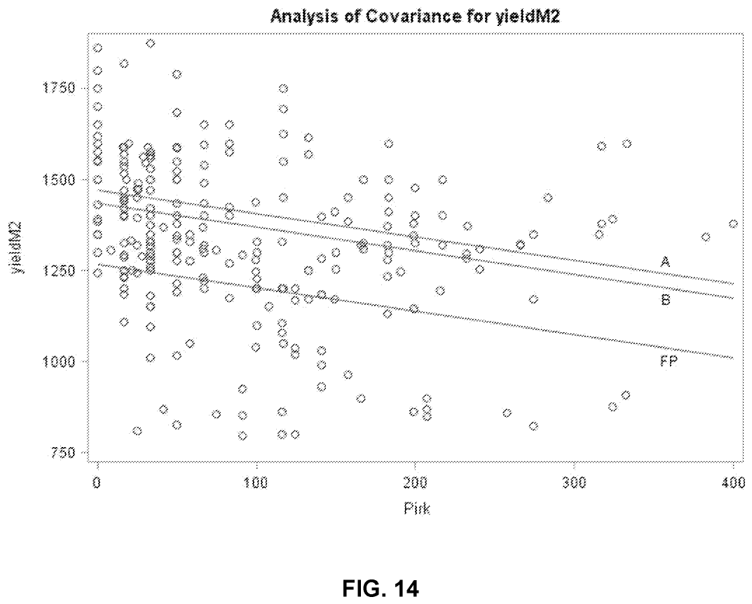

Yield and Dry Rot in Relation to Prep/ant Nematode Density: The analysis of covariance of yield and dry rot due to preplant nematode population densities within and between locations (FIGS. 13 and 14) accounts for much of the statistical variation over years and between farms. Pre-plant population densities of root-knot nematodes (Meloidogyne spp.) and S. bradys in soil demonstrate the relationship of these nematodes to yam yield and dry rot respectively. Both abamectin treated paper (PA) and banana paper only (PO) were effective in increasing yield over FP in the presence of Meloidogyne spp. regardless of initial population density (P≤0.01). Initial population density, however, negatively impacted yield and varied both within farms and between farms over years thus contributing to variation in yield across sites. Dry rot of yam was positively related to preplant densities of S. bradys (P≤0.01) and dry rot was reduced with paper treatments when compared to farmer practice. With both yield and dry rot, there was not a significant interaction of treatment with nematode density.

Interactions of treatments with locations and years were examined for individual years and individual farms. Yields were consistently increased with paper treatments across years, but six of the ten farms used in 2016 did not demonstrate a significant yam yield increase (P>0.05) in response to paper treatments. While the overall response for the 2016 yield was significant for all farms collectively, the significant yield increases for the four of the ten farms were enough to result in a significant overall increase in yield for 2016 comparable to that achieved in other years though somewhat smaller. Separate analysis of the farms where yield was not increased ((P>0.05) showed that the improved quality as indicated by lower (P≤0.01) dry rot related to treatment with paper, was still present and compensated for the lack of yield improvement.

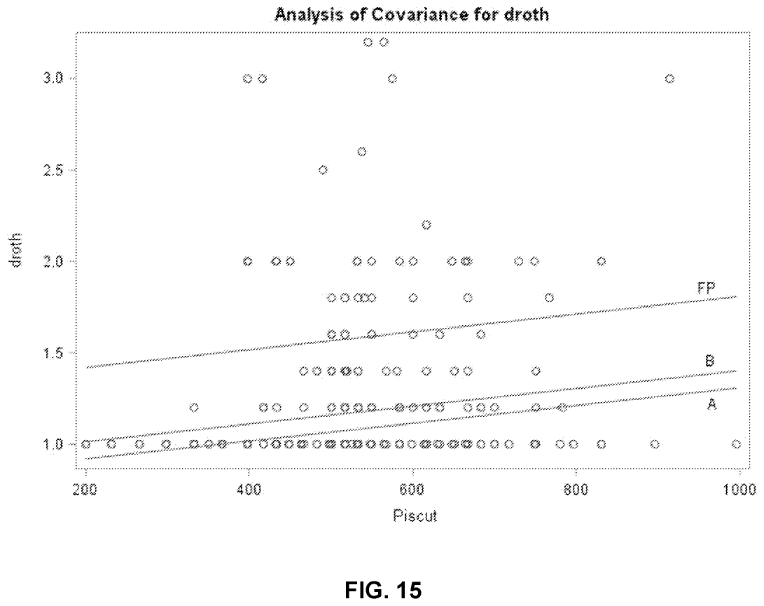

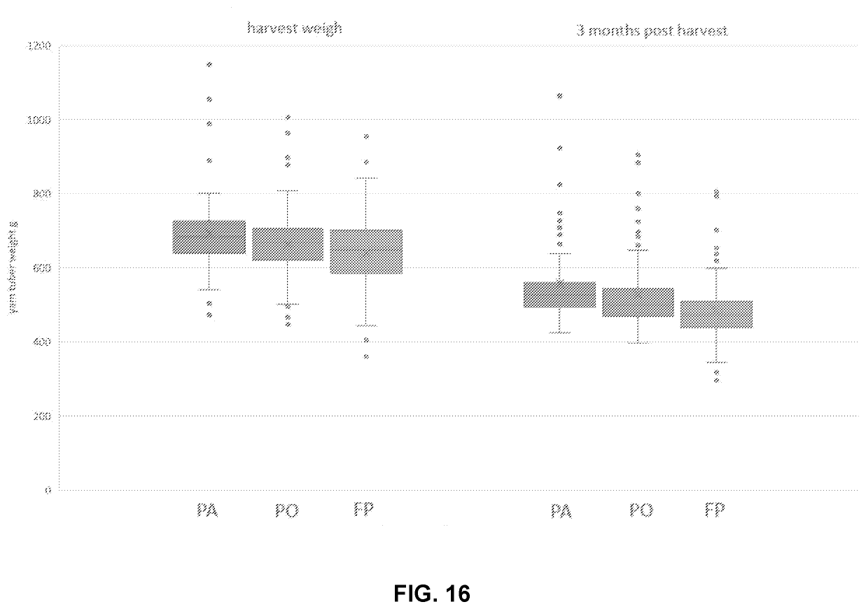

W&P effects on yam properties in storage for three months: Yam tuber weight at harvest was increased by paper treatments (FIG. 15, P≤0.01) from 2016 through 2018. The paper with abamectin (PA) treatment did not differ from the PO treatment which did not differ from the control (FP), but the PA treatment was greater than FP (lsd=31.2, α=0.01). Tuber weight decreased after 3 months in storage (FIGS. 15 and 16) compared to weight at harvest. After 3 months storage the average tuber weights of treatments were PA>PO>FP (lsd=26.5, α=0.01). The percent weight loss of tubers after three months was affected by paper treatments (FIG. 16), P≤0.01). Tubers from farmer treatment (FP) lost a greater percentage of weight than was found with PO treatments, and PO weight loss percent was greater than PA (lsd=0.81, α=0.01).

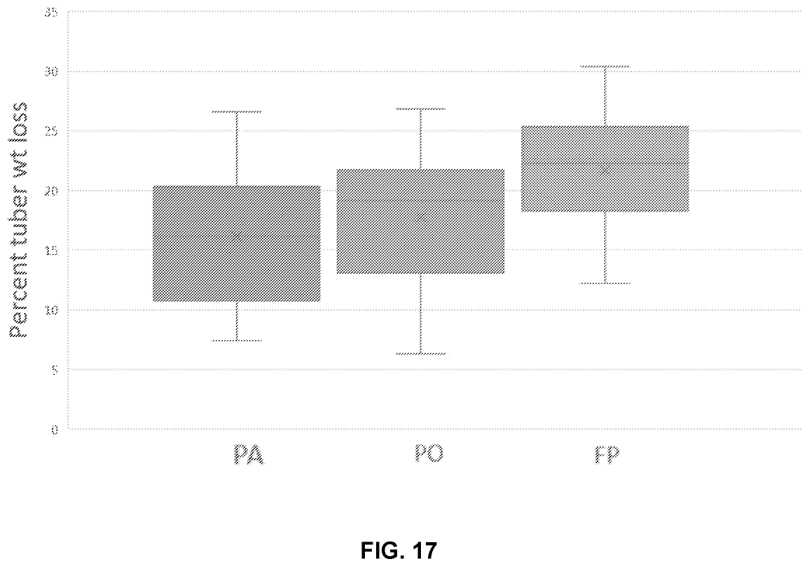

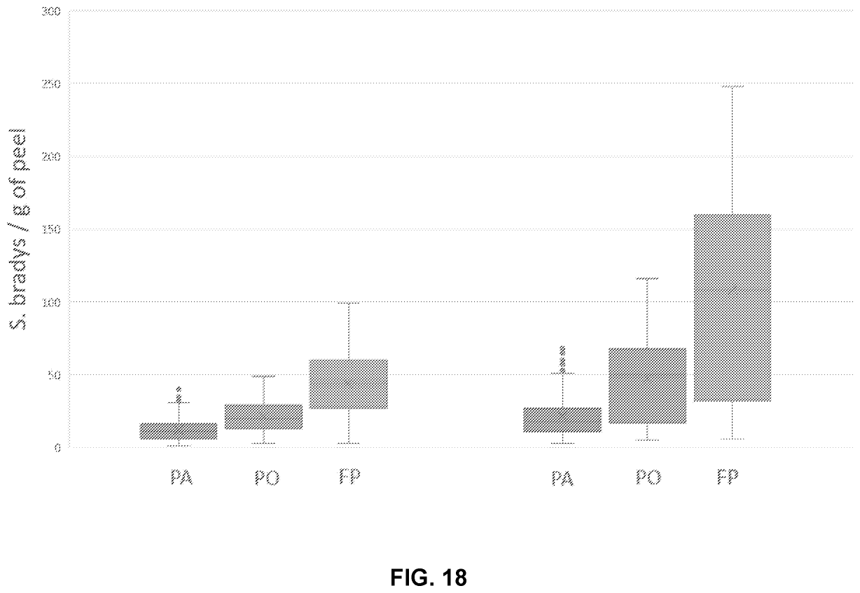

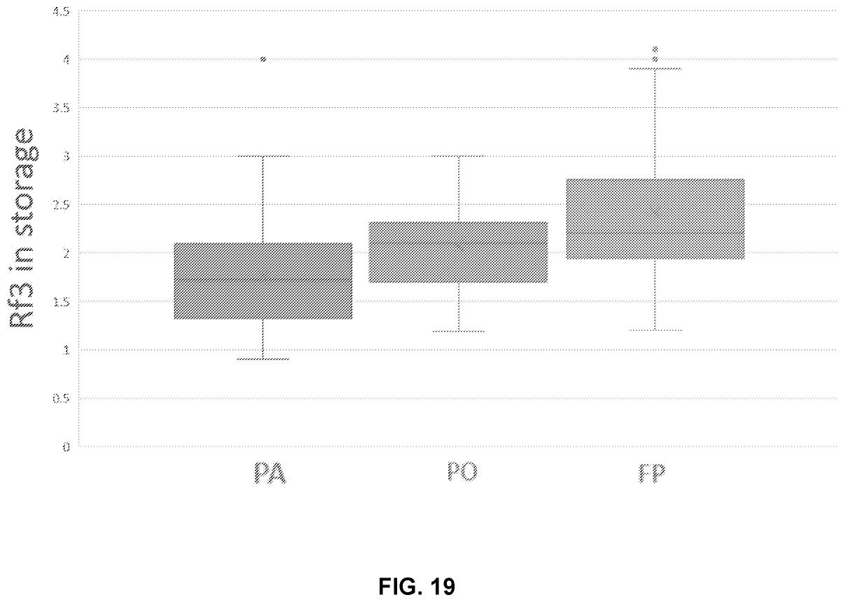

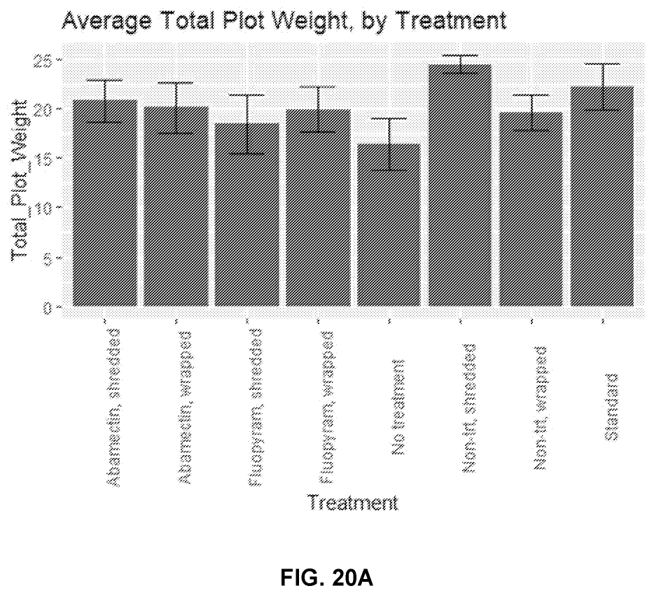

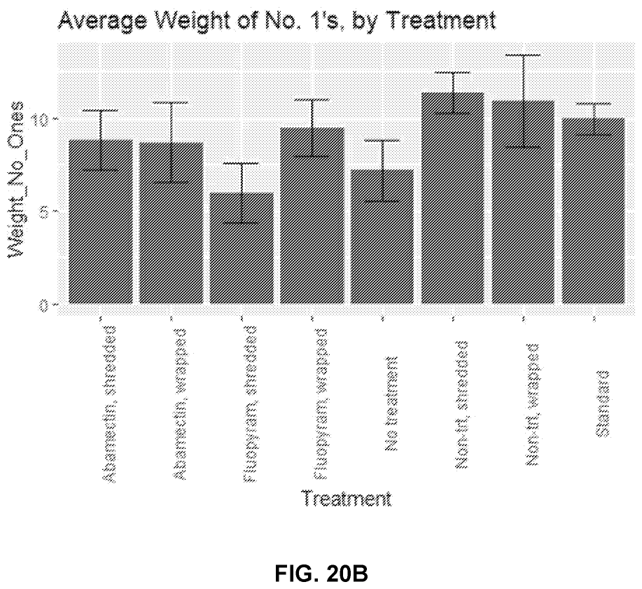

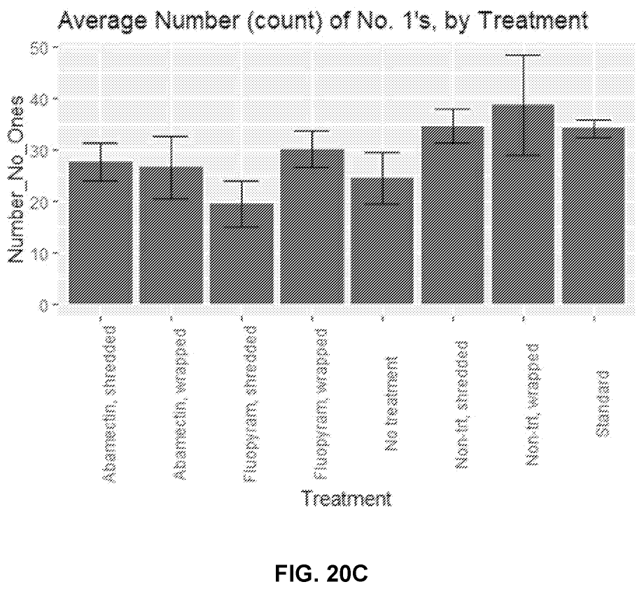

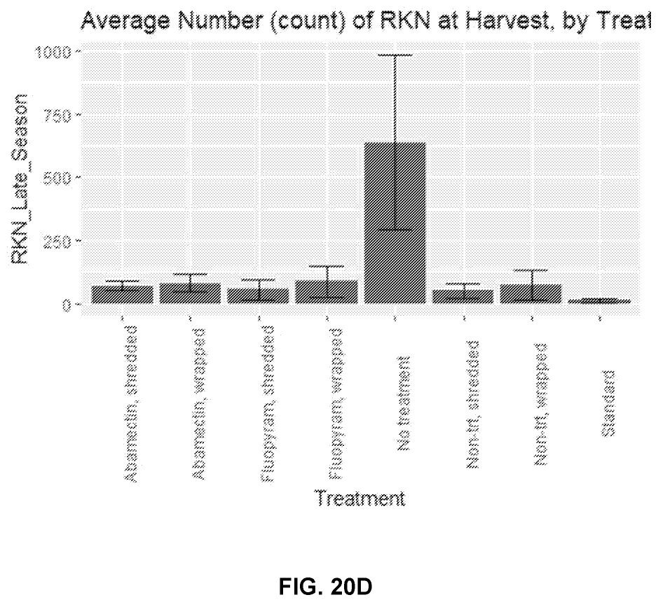

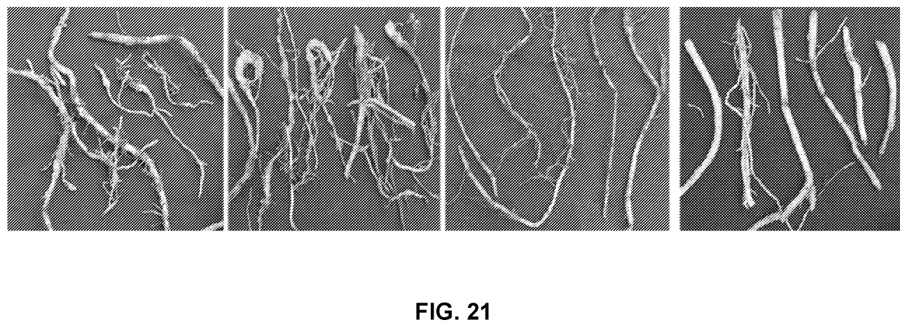

Population dynamics of Scutellonema bradys on yam tubers in storage: Wrap and plant treatments resulted in lower (P≤0.01) S. bradys population density per gram of peels at harvest than farmer practice (FIG. 17). The PA treatment had significantly lower nematode population densities than untreated (PO) banana paper that was also lower than farmer practice (FP) (lsd=1.41, α=0.01). Numbers of S. bradys in yam tuber peels increased in tubers after 3 months of storage (FIG. 17) and treatment differences in population density were still present (P≤0.01). Farmer practice (FP) had greater numbers than paper only (PO) treatments that were greater than abamectin treated paper (PA) (lsd=2.95, α=0.01). The reproductive rate of S. bradys (FIG. 18) was significantly different between treatments as indicated by the reproductive factor Rf. The reproductive rate for farmer practice over three months of storage was greater than PO and PA treatments and paper only (PO) Rf was less than treated (PA) banana paper (lsd=0.12, α=0.01).

### DISCUSSION

The consistency of yam yield and quality increases with W&P technology indicates the need to make this technology available on a large scale is western Africa. Yield increases of 10 to 15% occurred on 22 of the 28 farms evaluated in the study, and even when yield was unaffected, tuber quality was improved as a result of less tuber dry rot. The reduction in dry rot alone improves yam marketability and makes this simple technology worthwhile and profitable even when yield is not enhanced.

The negative impact of root-knot nematode initial density (Pi) on yam yield shows that the treated paper has a positive impact on yam yield regardless of the nematode density. Typically, paper treatments increased yield 10 to 15% at all root-knot preplant densities. Although the species of Meloidogyne present in the fields is unknown and specific pathogenicity to yam varies. Recently the highly virulent species Meloidogyne enterlobii has been identified in Benin and surrounding countries since the initiation of this research (Affokpon et al. 2016, Kolombia et al. 2016).

A negative impact of S. bradys on yield was observed but was not statistically significant in this research. The yam spiral nematode, S. bradys, however is ubiquitous on yam in this region, was present in soil at all locations used in this research, and is present on the seed tuber at planting (Coyne and Affokpon 2018). The presence of S. bradys in soil at every site and the small variation in numbers between sites limits the ability to use regression techniques to make quantitative conclusions. Additionally, the most important component of yield loss is S. bradys initial density in the peel at planting. Soil density is of secondary importance. Yam nematode in seed tubers at planting is the more important predictive component relative to yield as mentioned earlier (Atu and Obuji, 1985, Bridge, Coyne and Affokpon 2018). The amount of initial tuber infestation was not assessed in the current research, though this has been rectified in ongoing research.

The positive relationship of initial soil population density of S. bradys to yam dry rot supports other observations that S. bradys infection is correlated to yam dry rot, although there may be another organism present (Coyne and Affopon 2018, Kwoseh 2002). The positive relationship of yam dry rot and S. bradys numbers in soil suggests that edaphic factors that influence S. bradys are also favorable to dry rot.

Farmers indicated that “W&P” treatment resulted in larger, longer, and cleaner tubers ((Affokpon et al., 2018)). A preference study demonstrated that treatments positively impacted yam palatability. Many aspects of the food quality of cooked yam were increased while the desirability of yam flour was unaffected (Affokpon et al., 2018). Application of “W&P” technology resulted in significant reductions in final nematode populations compared to farmers' practice.

Reductions in yam tuber weight loss after 3 months storage associated with at planting paper treatments is an important aspect of this research. Improvements in storage preservation of food products provides for greater food security in a subsistence economy. Nematode respiration and reproduction on untreated tubers depletes available carbohydrate. Tuber weight and complete tuber loss during storage have long been considered as the bane that wipes out the effort and resources invested by yam stakeholders. Reduction in Yam tuber weight loss 3 months after harvest was as much as 21 percent in the case of tubers raised under farmer practices, whereas tubers from hills with paper treated with abamectin decreased by only 14 percent in weight.

Wrap and plant technology also affected the population densities of S. bradys at yam harvest and at three months after harvest. Lowest S. bradys populations densities were associated with the W & P tubers. Nematode reproduction on tubers during the three-month storage period was greatest with farmer practice tubers with a 3× increase in nematode density compared to paper alone (PO) treatment and of about a 5× increase compared to treated banana paper. Lower nematode density in peels would also provide for improved growth of the seed tuber at the start of the next growing season.

It must be noted that the lower nematode numbers, and lower reproductive factors are not result of residual abamectin in tubers. The lower reproductive rates as indicated with paper wrapped tubers are due to a lower nematode population at harvest in treated tubers than untreated tubers. Rf is a linear measure over a single relatively short time interval, since the actual reproductive rate is exponential, higher numbers initially are primary in determining the Rf.

Lower S. bradys population density in seed tubers for the next year can have positive effects on the subsequent crop, since planted seed tubers would contribute less yam nematode to the Pi of that year. The benefits of hot water treatment or nematicide treatment of yam tubers resulted in improved growth even in subsequent years, due in part to seed tubers with lower nematode density at planting (Adesiyan and Badra 1982, Badra and Caveness 1979, Bridge 1975, Cadet and Daly 1996, Claudius-Cole et al. 2017, Kenyon et al. 2005). One would expect to see the same positive effects with the Wrap and Plant technology.

Lower harvest density of S. bradys with treatment is an unusual situation from the perspective of traditional nematode management. Effective suppression of plant nematodes on crops at the beginning of the season often results in a rapid resurgence of nematode numbers because these obligate parasites have an unlimited food supply (Melton et al. 1996). Plant parasitic-nematodes that remain vermiform throughout their life cycle such as yam spiral nematode have a low reproductive rate relative to nematodes such as root-knot. Effective S. bradys suppression to a very low level can limit population resurgence such that the yam nematode cannot increase to the carrying capacity in only one season and or storage cycle.

The relationship of root-knot nematode density to yam yield and the yam spiral nematode to dry rot with respect to treatments are parallel (treatments are not density dependent). Thus, paper treatments improve yield and quality regardless of preplant nematode soil density and will give a positive response under most conditions where yam seed stock is infested with S. bradys. The addition of abamectin to the paper adds about 5% greater yield or quality. The lack of interaction and the relatively small differences between treated and untreated paper indicates that mechanisms other than direct toxicity of abamectin to the nematode are occurring. The paper alone is surprisingly the more important component of the treatment. The paper alone treatment (PO) improved yield and dry rot above untreated farmer practice by 12.5% and 31% respectively while treated paper (PA) improved yield and dry rot by 15% and 38%. Since the addition of abamectin improves yield and dry rot, and more importantly suppresses further nematode development on stored tubers, the addition of abamectin is justified. It is interesting to note though, that the cost of the paper used is greater than that of the abamectin. Pesticide residues are not relevant when considering abamectin. It is a large hydrophobic organic molecule that is not systemic in the plant (Khalil and Darwesh, 2019). The movement, and half-life of the abamectin (a biological fermentation product) in soil are all extremely low. Abamectin in harvested tubers would be undetectable and likely absent altogether. The lower nematode numbers associated with abamectin treatment indicate that the efficacy of the at planting treatment in suppressing nematode reproduction.

The statistical interactions can be accounted for by many other factors besides varying nematode species and initial densities, including: 1) field trials conducted under crude conditions; 2) much of the variation in yield was due to the degree of the response to treatments and whether paper differed from untreated paper; 3) locations were not irrigated which would account for both interactions between farms and over years; and 4) soils differed across farms, farmer practices were not uniform, and variations associated with land race of yam need to be considered. While S. bradys was present at all locations and the initial population density of this nematode in soil differed at least as much within a given farm as between locations. A better indicator of S. bradys population density on yam yield and quality is likely the numbers of S. bradys present in the seed piece. Finally, root-knot (Meloidogyne spp.) and lesion (Pratylenchus spp.) nematodes were found at some locations and not at others and the species of root-knot nematode can greatly affect results.

That the responses of yield, dry rot and nematode population measures to untreated paper was almost equal to abamectin treated paper was unexpected. Comparison of untreated to treated paper abamectin component demonstrates that the banana paper is perhaps the most important component in treatment performance. The addition of abamectin improves the response with enhanced nematode control, likely in the seed tuber, but though stastically superior to paper alone provides only a moderate improvement. The suppression of nematode damage shown in this research with W&P may have many facets. The treated paper may be toxic to nematodes in the tuber as well as nematodes in the surrounding soil. Banana paper whether treated or untreated may act as a barrier to prevent egress of the nematodes from the seed tuber to attack yam roots as they emerge and move through the soil. Equally plausible is that paper may prevent soil nematodes from penetrating the yam seed tuber and or new roots formed in early growth. It also demonstrates that the action of wrapping a yam seed piece at planting with paper has had a measurable impact on the nematode population at yam harvest in addition to increasing yam yield and quality. Wrap and plant technology would appear to be analogous to the benefits achieved with hot water treatment or chemical treatment of yam tubers (Adesyan and Badra; 1985, Badra and Caveness, 1979; Bridge, 1975; Coyne et al 2006; Kenyon, 2005). Hot water treatments, however, require equipment and expertise that is not available to smallholder farms. Nematicide treatment of seed tuber (Adeysian and Badra; 1982; Badra; 1985; Badra and Caveness 1979; Bridge 1975) could be used to improve planting material, but the toxicity of most nematicides makes this an inappropriate technology for untrained farmers (Goulson, 2020). Wrap and plant technology avoids the aforementioned constraints

The adoption of the W&P technique can improve yield and quality, thus positively impacting yam production in western Africa. The improvement in local diets as a result of the application of this technology as well as the ability to produce income from additional production can improve the quality of life in this region. More and better primary product is available for consumption and or sale and better quality after storage as well as quantity. Enhanced profitability, desirability, and yam palatability as a result of these treatments has also been observed. Wrap and plant has a distinct advantage to other means of improving yam production especially as it pertains to nematode management: it is inexpensive, simple to use, and safe.

These factors are all important components of food security and safety that can be implemented in a part of the world that faces many challenges.

Banana is an important food and export crop in Africa and it is estimated that wastes produced by a single banana plant is 80% of its mass, which is mostly used as animal feed or fuel (Papao et al. 2015; Pamd et al. 2014). Generation of abundant wastes from banana harvest, taken together with comparatively low content of lignin and higher amount of cellulose, makes the wastes of banana harvests an attractive candidate for paper production (Prizada et al. 2020).

Banana is grown throughout Africa and residual banana plant residue is available locally, thus providing the raw material for paper. The use of banana paper as a carrier for delayed release of micro doses of agrochemicals and or biological products for crop protection is a potential new tactic for pest management, especially for tropical crops. Abamectin incorporated on banana paper could be as effective as chemical nematicides for control of nematodes in tubers, while avoiding toxicity problems encountered with nematicides.

Conclusions

Deployment of the “Wrap and Plant” technique in Western Sub-Saharan yam production can increase productivity of this crop for subsistence farmers. The technique serves to mitigate yield and quality suppression of yams caused by plant-parasitic nematodes. The minimal cost, simplicity, and safety makes this technology appropriate to smallholder farmers. The materials for this approach can be sourced locally and need be made available through existing distribution systems. This approach to nematode management in the underdeveloped tropics likely has applications to other tuber crops such as cassava, white potatoes, and sweet potatoes.

### Example 3: How Various Species, Parts of Banana Plant and their Blends with Various Fibers Alter the Attributes of the Matrix

As disclosed herein, using lignocellulosic fiber from a variety of sources in varied proportions and or by altering processing techniques matrices, with a range of physical attributes could be produced. As a demonstration of this, a collection of matrices made of varied source fiber and processing techniques were made. These matrices were characterized in a variety of assays to determine variations in their attributes. Table 4 list the various samples and their physical attributes prepared from different types of fibers and fiber blends, while Table 5 and 6 relate thickness of fiber blends and various types of banana fibers respectively with their sorption efficiency and % release profile for rhodamine B as model molecule.

TABLE 4
Apparent density, Air resistance, burst, tear and tensile indices of
paper produced from pure banana fiber removed from different species
and parts of banana plant and also from bledns produced from old corrugated
cardboard (OCC) and banana fiber (BF) in various compositions

| | Apparent | Air | Burst | Tear | Tensile |
|---|---|---|---|---|---|
| | Density | resistance | Index, | Index, | Index, |
| Banana species | (kG/m³) | (gs/100 ml) | (Kpa · m²/g) | (mN · m²/g) | (N · m/g) |
| Musa acuminata | 281.01 | 0.355 | 2.15 | 3.62 | 0.1644 |
| Musa basjoo | 201.95 | 2.05 | 3.325 | 8.74 | 0.208 |
| Musa sikkemensis | 307.54 | 62.063 | 10.8 | 7.95 | 0.0298 |
| Musa balbisiana | 274.4 | 14.47 | 6.66 | 9.87 | 0.023 |
| Musa germplasm | 244.54 | 0.00 | 0.2394 | 5.53 | — |
| (stalk) | | | | | |
| Musa germplasm | 276.92 | 0.4 | 0.4206 | 7.32 | 0.201 |
| (peduncle) | | | | | |
| Musa germplasm | 306.77 | 1.06 | 0.2579 | 2.24 | 0.176 |
| (rachis) | | | | | |
| BF:OCC in 80:20 | 294.52 | 1.28 | 1.86 | 4.77 | 0.0104 |
| BF:OCC in 60:40 | 411.97 | 15.04 | 2.84 | 3.07 | 0.0117 |
| BF:OCC in 40:60 | 440.08 | 14.26 | 3.59 | 4.13 | 0.02113 |
| BF:OCC in 20:80 | 493.07 | 9.08 | 4.37 | 3.19 | 0.0215 |

TABLE 5
Thickness, % release and sorption efficiency of papers prepared
from banana fiber (BF), old corrugated cardboard (OCC) OCC-BF
blends, bagasse, mixed bagasse fibers and blends with BF,
OCC banana leaves and BF wet and dried banana peels

| | | | Sorption |
|---|---|---|---|
| | Thickness | % RhB | efficiency |
| Paper | (μm) | released | (mg/g) |
| Banana fiber (BF) | 600 | 47.5 | 51.3 |
| Old corrugated cardboard (OCC) | 150 | 12.5 | 18.11 |
| BF:OCC in 80:20 | 211.1 | 26.14 | 54.45 |
| BF:OCC in 60:40 | 185.8 | 12.92 | 70.6 |
| BF:OCC in 40:60 | 173.5 | 12.8 | 45.57 |
| BF:OCC in 20:80 | 156.4 | 12.1 | 55.48 |
| OCC:banana leaves in 80:20 | 793 | 58.8 | 4.33 |
| BF:wet peels in 80:20 | 512 | 47.87 | 5.09 |
| BF:dry peels in 80:20 | 550 | 57.24 | 4.85 |
| Bagasse | 242 | 36.46 | 22.67 |
| Bagasse mix | 202 | 49.03 | 16.16 |
| BF:BG in 80:20 | 328 | 49.26 | 26.73 |
| BF:BG mix in 80:20 | 397 | 30.8 | 18.54 |
| BF:BG in 60:40 | 319 | 44.9 | 24.68 |
| BF:BG mix in 60:40 | 423 | 54.05 | 17.93 |

TABLE 6
Thickness, % release and sorption efficiency of fibers
removed from various species and parts of banana plants
collected from Costa Rica, USA, Uganda and Tanzania

| | | | | Sorption |
|---|---|---|---|---|
| | | Thickness | % RhB | efficiency |
| Banana species | Origin | (μm) | released | (mg/g) |
| Musa acuminata | Costa Rica | 600 | 47.5 | 51.3 |
| Musa basjoo | USA | 336 | 10.8 | 5.74 |
| Musa sikkemensis | USA | 188 | 44 | 6.46 |
| Musa balbisiana | USA | 224 | 11.3 | 4.5 |
| Kitooke Kiganda | Uganda | 481 | 50.5 | 3.12 |
| Mbwazirume | Uganda | 570 | 46.04 | 3.7 |
| Nakanyaoga | Uganda | 411 | 51.1 | 2.62 |
| Sukali Ndiizi | Uganda | 318 | 62.3 | 4.52 |
| Musa germplasm (stalk) | Tanzania | 202 | 60.6 | 2.89 |
| Musa germplasm | Tanzania | 262 | 41.02 | 3.5 |
| (peduncle) | | | | |
| Musa germplasm (rachis) | Tanzania | 206 | 39.98 | 4.9 |

### Example 4. Shredded Solid Phase Formulations of a Fungicide

As disclosed herein, treatment of the matrix with fungicides would produce effective formulations for pathogen control. A field trial with shredded matrix treated with Thiabendazole (Mertect) with sweet potatoes was conducted.

Black Rot in sweet potato results in significant crop loss. Infestation can occur in early growth and result in plant death. Symptoms can also appear at harvest or during storage and consist of a dry, firm, dark-colored rot that does not extend into the cortex of the sweet potato root. The pathogen causing Black Rot on sweet potatoes is the ascomycete fungus Ceratocystis fimbriata. The trial is being conducted at the North Carolina Department of Agriculture Central Crops Research Station in Clayton North Carolina. Current farmer practice in treatment against Black Rot is to dip the sweet potato slips into a solution of Mertect™ (Thiabendazole). For this trial 6 test condition were used with 4 replicates. The conditions are No treatment, 2 unidentified biological test strains, Mertect™ dipped slips (farmer practice), Non-treated paper shred, Mertect™ treated paper shred.

The field was infested with Black rot prior to planting with the trial planted. The plants were scored for early growth and vigor on a weekly basis. At the five week point in the test it was observed that compared to other years the early plant death was higher than normal with greater than 50% of the non-treated reps gone. The shredded paper (both treated and non-treated) show reduced plant death compared to the no treatment control. There was observable rep to rep variation for all treatments. The treated paper show visibly better early growth than the non-treated paper (greater survival and plant size).

### Example 5. Solid Phase Matrix Treated with Abamectin Retains Bioactivity in Soil for Greater than 21 Days

As disclosed herein, the use of a solid phase matrix for the delivery of agrochemical increase the half-life of agrochemicals in soil by greater than 200%. To determine the nematocide half-life of solid phase matrix in soil a greenhouse based assay was developed.

Retention of Bioactivity and Integrity in Soil Assay

Two attributes thought to be important for performance in soil, are retention of paper integrity and bioactivity. To evaluate this a greenhouse assay is used. In the assay one cm squares of the various papers are loaded with abamectin. The squares are placed in pots with soil and a tomato plant. After various time periods, the squares are recovered and tested for presence of bioactivity as determined by acute toxicity to C. elegans. The acute toxicity is determined by placing a 6 mm disk of test material in a well of a 48 well microtiter plate. Two hundred ul of M9 buffer is added and the disk equilibrated for 24 hours. Next 100 C. elegans are added and after an additional 24 period the nematodes are check for bioactivity. Abamectin is an anthelmintic agent causing paralysis in nematode upon exposure. Bioactivity is measured by looking for the loss of motility at a concentration of 100 ppb.

Effect of Soil Composition on Retention of Bioactivity

It is believed that abamectin has limited efficacy arises from it becoming bound to the clay and organic components of soil. To test if the composition soil alters the retention of integrity or bioactivity test were performed in four diverse soils (NC Black soil, NC red clay soil, Sandy Loam and Sand). Surprisingly little difference was observed in performance in the different soils (Table 7A).

Paper Composition

To determine if paper composition alters the retention of integrity and bioactivity in soil a range of paper compositions were tested. Results for papers derived from a variety of banana species and tissue types are shown in Table 7B. Most of these papers showed similar length for both retention of bioactivity. The retention of integrity was always longer retention of bioactivity but both showed similar trend. The significant exception is derived banana fiber peduncle that showed shorter retention of both bioactivity and integrity. In addition to banana fiber based paper other wood based papers were tested Table 7D. Significant variation in duration of bioactivity and integrity were seen between the different papers as compared to the banana based samples. These results suggest multiple attributes in paper may play a role in how wrap and plant provides crop protection.

TABLE 7A
Retention of bioactivity and Integrity in different soil types

| | Bioactivity | | Integrity | |
|---|---|---|---|---|
| Soil Type | (days) | +/− | (day) | +/− |
| Sand | <28 | 4 | <42 | 4 |
| Sandy loam | >21 < 28 | 4 | <35 | 4 |
| NC Red Clay | >21 < 28 | 4 | <35 | 4 |
| NC Brown Clay | >14 < 21 | 4 | <35 | 4 |
| NC Eastern Black Soil | >21 < 28 | 4 | >28 < 35 | 4 |

TABLE 7B
Retention of bioactivity and Integrity
in different species and tissue type

| | Bioactivity | | Integrity | |
|---|---|---|---|---|
| Species or Tissue | (days) | +/− | (day) | +/− |
| Mulberry | 21 days | 4 | 14-21 | 4 |
| 2015 raw banana paper | 21 days | 4 | 14-21 | 4 |
| Peduncle | >14 < 21 | 4 | 16 | 2 |
| Rachi | >14 < 21 | 4 | 20 | 7 |
| Stalk | >21 < 28 | 4 | 28 | 4 |

TABLE 7C
Retention of bioactivity and Integrity
in different types of wood fiber paper

| | Bioactivity | | Integrity | |
|---|---|---|---|---|
| Paper type | (days) | +/− | (day) | +/− |
| Liner paper | 14-21 | 4 | 14-21 | 4 |
| Paper towel | 14-21 | 4 | 14-21 | 4 |
| copy paper | 14-21 | 4 | 14-21 | 4 |
| card stock | 14-21 | 4 | 14-21 | 4 |
| brown hand towels | <7 | 4 | <7 | 4 |
| OCC | 14 > 21 | 4 | 14 > 21 | 4 |
| Bleached | 7 > 14 | 4 | 7 > 14 | 4 |

### Example 6: Efficacy of Using Solid Phase Matrix in a Slip Cover Pouch Treated with Fluopyram for Nematode Control on Sweet Potato

As disclosed herein, by folding the solid phase into a pouch to cover sweet potato slip will result in effective nematode control and increased yield. This format was chosen to be compatible with exist practice of semi-automated planting. Field trials using slip pouches treated with fluopyram on sweetpotatoes were conducted. Below is a summary of the results from the field trial.

Location: The field trial was conducted on a farm in Woodington, NC. The field was confirmed positive for Meloidogyne enterolobii through NCDA Nematode Assay Lab analysis.

Trial set-up: Sweet potatoes (cv. Covington) were planted at 11 inch within row spacing and 42 inch rows. Plots were 4 rows wide by 10 ft long, with 10 feet between plots. Plots were maintained by the grower collaborator using standard agronomic practices. Vigor data, soil samples for mid-season nematode counts, and harvest data was collected. At harvest, the middle two rows of each plot were dug by hand and tubers assessed. Data were analyzed, plotted, and effect of treatment on yield and nematode variables was assessed through mean separation in R (v. 3.6.2).

Formulations and Application rates: Six different wrap and plant formulations and 2 control treatment were tested. Table 8 describes the test conditions and application rates.

TABLE 8
Treatments and Application Rates

Application rate

| | Treatment | gm/acre | ug/plant |
|---|---|---|---|
| 1 | Fluopyram wrapped | 0.17 | 10 |
| 2 | Fluopyram Shredded | 0.17 | 10 |
| 3 | Grower Standard Fluopyram | 100 | 5700 |
| 4 | Abamectin Wrapped | 0.17 | 10 |
| 5 | Abamectin Shredded | 0.17 | 10 |
| 6 | Non-treated wrap | 0 | 0 |
| 7 | Non-treated Shredded | 0 | 0 |
| 8 | No Treatment | 0 | 0 |

Yields and Population data with Averages and Standard Deviations: Tables 9 and 10 present the data collected from the trial. For each plot the tuber were collect and sorted into 2 groups: #1 grade and cutters/jumbos. In addition, the number of #1 tubers were counted.

At harvest a soil sample from each plot was collected and 100 cc of soil extracted to determine nematode populations. Three genera of nematode were observed (RKN, stunt and lesion). Counts for the two highest population species, RKN and Lesion at the harvest sampling are reported per 100 g of soil. Population counts of RKN, lesion, and stunt nematode were transformed (log 10(n+1)) prior to analysis to fit assumptions of normality.

TABLE 9
Field Data

| | | | | | | Root Knot | Lesion |
|---|---|---|---|---|---|---|---|
| | | Total | | Yield of | No. | Nematode | Nematode |
| | Plot | Yield | Yield of | Jumbo & | of #1 | at harvest | at harvest |
| Treatment | Position | (kg) | #1 (kg) | Canners (kg) | tubers | (/100 cc of soil) | (/100 cc soil) |
| 1 | 8 | 18.6 | 9.8 | 8.8 | 35 | 50 | 125 |
| 1 | 11 | 26.7 | 13.6 | 13.1 | 37 | 275 | 50 |
| 1 | 23 | 18.2 | 8.15 | 10.05 | 27 | 0 | 25 |
| 1 | 25 | 16.1 | 6.35 | 9.75 | 23 | 25 | 0 |
| 2 | 4 | 19.7 | 8.7 | 11 | 27 | 0 | 50 |
| 2 | 10 | 19.65 | 5.45 | 14.2 | 17 | 175 | 25 |
| 2 | 15 | 24.15 | 8.05 | 16.1 | 26 | 0 | 0 |
| 2 | 31 | 10.1 | 1.6 | 8.5 | 8 | 50 | 50 |
| 3 | 2 | 22.8 | 9.35 | 13.45 | 32 | 25 | 250 |
| 3 | 9 | 28.05 | 12.15 | 15.9 | 36 | 0 | 50 |
| 3 | 20 | 20.9 | 9.75 | 11.15 | 30 | 25 | 75 |
| 3 | 27 | 16.8 | 8.1 | 8.7 | 38 | 0 | 100 |
| 4 | 6 | 18.15 | 9.2 | 8.95 | 30 | 50 | 225 |
| 4 | 7 | 25.95 | 10.4 | 15.55 | 31 | 25 | 75 |
| 4 | 22 | 22.1 | 12.5 | 9.6 | 36 | 75 | 75 |
| 4 | 32 | 14.1 | 2.65 | 11.45 | 9 | 175 | 0 |
| 5 | 5 | 26.85 | 13.2 | 13.65 | 38 | 25 | 150 |
| 5 | 14 | 20.7 | 8.75 | 11.95 | 27 | 50 | 0 |
| 5 | 24 | 17.35 | 7.45 | 9.9 | 24 | 100 | 25 |
| 5 | 28 | 18.15 | 5.8 | 12.35 | 21 | 100 | 0 |
| 6 | 12 | 23 | 12.9 | 10.1 | 38 | 50 | 25 |
| 6 | 16 | 20.7 | 13.5 | 7.2 | 46 | 0 | 25 |
| 6 | 17 | 20.85 | 14.15 | 6.7 | 58 | 250 | 0 |
| 6 | 29 | 14.35 | 3.65 | 10.7 | 12 | 0 | 25 |
| 7 | 1 | 26.6 | 14.2 | 12.4 | 42 | 0 | 200 |
| 7 | 13 | 24.55 | 11.75 | 12.8 | 37 | 100 | 200 |
| 7 | 18 | 22.3 | 9.1 | 13.2 | 27 | 100 | 50 |
| 7 | 21 | 24.3 | 10.45 | 13.85 | 32 | 0 | 50 |
| 8 | 8 | 23.1 | 10.5 | 12.6 | 33 | 25 | 50 |
| 8 | 19 | 15.35 | 9.55 | 5.8 | 33 | 200 | 50 |
| 8 | 26 | 10.55 | 4.1 | 6.45 | 18 | 1550 | 200 |
| 8 | 30 | 14.25 | 4.6 | 9.65 | 14 | 775 | 25 |

TABLE 10
Average and Standard Deviation by treatment.

| | | | | | | | |
|---|---|---|---|---|---|---|---|
| Fluopyram | Fluopyram | Grower | Abamectin | Abamectin | Non-treated | Non-treated | No |
| wrapped | Shredded | Standard | Wrapped | Shredded | wrap | Shredded | Treatment |

Yield #1 Tubers in Kg

| | | | | | | | | |
|---|---|---|---|---|---|---|---|---|
| | 9.8 | 8.7 | 9.4 | 9.2 | 13.2 | 12.9 | 14.2 | 10.5 |
| | 13.6 | 5.5 | 12.2 | 10.4 | 8.8 | 13.5 | 11.8 | 9.6 |
| | 8.2 | 8.1 | 9.8 | 12.5 | 7.5 | 14.2 | 9.1 | 4.1 |
| | 6.4 | 1.6 | 8.1 | 2.7 | 5.8 | 3.7 | 10.5 | 4.6 |
| Average | 9.5 | 6.0 | 9.8 | 9.5 | 8.8 | 11.1 | 11.4 | 7.2 |
| Std Dev | 3.1 | 3.2 | 1.7 | 4.2 | 3.2 | 5.0 | 2.2 | 3.3 |

RKN Population

| | | | | | | | | |
|---|---|---|---|---|---|---|---|---|
| | 50.0 | 0.0 | 25.0 | 50.0 | 25.0 | 50.0 | 0.0 | 25.0 |
| | 275.0 | 175.0 | 0.0 | 25.0 | 50.0 | 0.0 | 100.0 | 200.0 |
| | 0.0 | 0.0 | 25.0 | 75.0 | 100.0 | 250.0 | 100.0 | 1550.0 |
| | 25.0 | 50.0 | 0.0 | 175.0 | 100.0 | 0.0 | 0.0 | 775.0 |
| Average | 87.5 | 56.3 | 12.5 | 81.3 | 68.8 | 75.0 | 50.0 | 637.5 |
| Std Dev | 126.7 | 82.6 | 14.4 | 65.7 | 37.5 | 119.0 | 57.7 | 687.5 |

Lesion Population

| | | | | | | | | |
|---|---|---|---|---|---|---|---|---|
| | 125 | 50 | 250 | 225 | 150 | 25 | 200 | 50 |
| | 50 | 25 | 50 | 75 | 0 | 25 | 200 | 50 |
| | 25 | 0 | 75 | 75 | 25 | 0 | 50 | 200 |
| | 0 | 50 | 100 | 0 | 0 | 25 | 50 | 25 |
| Average | 50 | 31.25 | 118.75 | 93.75 | 43.75 | 18.75 | 125 | 81.25 |
| Std Dev | 54.01 | 23.94 | 89.85 | 94.37 | 71.81 | 12.50 | 86.60 | 80.04 |

Data Correlations: Correlations between yield, nematode and position parameters were made. Table 11A list combination with correlations values greater than ±0.25.

TABLE 11A
Correlation coefficients and associated P-values
before transformation of nematode count data

| | | Correlation | |
|---|---|---|---|
| Parameter 1 | Parameter 2 | Coefficient | P-value |
| Total Yield | Plot Location | 0.72 | <0.001 *** |
| Total Yield | RKN Population | −0.45 | 0.009 *** |
| | Final | | |
| Yield No. 1 | Lesion Population | 0.23 | 0.200 |
| | Final | | |
| Paper Format | RKN Population | 0.48 | |
| Paper Format | Lesion Population | 0.14 | |
| Total Yield | RKN Population | 0.22 | 0.222 |
| | Mid-Season | | |
| Total Yield | Stunt Population | 0.06 | 0.734 |
| | Mid-Season | | |
| RKN Population | Plot Location | 0.31 | 0.088 |
| Final | | | |
| Lesion | Plot Location | −0.47 | 0.006 ** |
| Population Final | | | |

TABLE 11B
Correlation coefficients and associated P-values after transformation
of nematode count data to fit assumptions of normality

| | | Correlation | |
|---|---|---|---|
| Parameter 1 | Parameter 2 | Coefficient | P-value |
| Yield No. 1 | RKN Population Final | −0.212 | 0.245 |
| Total Yield | RKN Population Final | −0.310 | 0.084 |
| Total Yield | Lesion Population Final | 0.187 | 0.306 |
| Yield No. 1 | Lesion Population Final | 0.267 | 0.139 |
| Total Yield | RKN Population Mid- | 0.267 | 0.140 |
| | Season | | |
| Yield No. 1 | RKN Population Mid- | 0.361 | 0.042 * |
| | Season | | |
| Total Yield | Stunt Population Mid- | 0.092 | 0.615 |
| | Season | | |
| Yield No. 1 | Stunt Population Mid- | 0.250 | 0.167 |
| | Season | | |
| Number of #1's | RKN Population Final | −0.193 | 0.291 |
| Number of #1's | Lesion Population Final | 0.181 | 0.320 |
| Number of #1's | Plot Location | −0.549 | 0.001 *** |

Data Sorting: The data was sorted by treatment and average yield and population data. Table 12 presents results of sorts for treatment vs yield, RKN population and Lesion population.

TABLE 12
Data sorted by Treatment vs Yield and Nematode Population

Treatment

| | Average Total Yield |
|---|---|
| No Treatment | 16.3 |
| Fluopyram Shredded | 18.4 |
| Non-treated wrap | 19.7 |
| Fluopyram wrapped | 19.9 |
| Fluopyram Shredded | 18.4 |
| Abamectin Shredded | 20.8 |
| Grower Standard | 22.1 |
| Non-treated Shredded | 24.4 |
| | Average RKN Population at Harvest (/100 cc soil) |
| Grower Standard | 12.5 |
| Non-treated Shredded | 50 |
| Fluopyram Shredded | 56.25 |
| Abamectin Shredded | 68.75 |
| Non-treated wrap | 75 |
| Abamectin Wrapped | 81.25 |
| Fluopyram wrapped | 87.5 |
| No Treatment | 637.5 |
| | Average Lesion Population at Harvest |
| | (/100 cc soil) |
| Abamectin Wrapped | 93.75 |
| Grower Standard | 118.75 |
| Fluopyram Shredded | 31.25 |
| Abamectin Shredded | 43.75 |
| Fluopyram wrapped | 50 |
| Non-treated wrap | 18.75 |
| Non-treated Shredded | 125.00 |
| No Treatment | 81.25 |

Notable points:
1) Strong correlation exists on plot position and yield, suggesting field variation and environmental factors contributed significantly to total yield.
2) Significant difference exists in application rates.
3) Final Non-Treated control nematode counts show field had moderate root-knot nematode pressure. However, no visible RKN galling damage was observed on #1 tubers during harvest assessment—this may be attributed to mixed populations of M. enterolobii and M. incognita, with low populations of M. enterolobii.
4) There is negative correlation with total yield and RKN population at harvest (rho=−0.310, P=0.084), and is significant at the alpha=0.10 level.
5) There was a significant positive correlation between mid-season RKN population and yield of #1's (rho=+0.361, P=0.042). This positive correlation is contrary to what may be hypothesized, i.e. higher RKN population leads to greater yield (?!). However, this relationship has been noted in the literature, with an alternative hypothesis that relatively small populations of RKN may induce more root growth, thus contributing to more root biomass and potential a minor yield increase. Alternatively, plants with naturally greater root biomass may support higher populations of RKN without corresponding reductions in yield.
5) Average population of RKN nematode detected increased between mid-season and harvest assessment.
6) All formulations displayed an increase in total yield over Non-Treated control, but differences were not statistically significant at the alpha=0.05 level. All formulation with the exception of the Flupyram Shredded displayed an increase in yield of #1's over Non-Treated control, but the differences were not statistically significant at the alpha=0.05 level.
7) Final Lesion population vs treatment showed an interesting relationship, with no discernable pattern present. Further analysis may be needed to understand effect of treatment on lesion populations.
8) All formulations displayed suppression of final RKN population over the Non-Treated control. However, this relationship was not statistically significant at the alpha=0.05 level after transformation of the nematode count data (log 10(n+1)). Although not statistically significant, this level of RKN suppression could be beneficial from long-term root-knot nematode management.

### Example 7: Efficacy of Using Solid Phase Matrix Treated with Abamectin for Crop Protection of Root Stock and Slip Propagated Crops

As disclosed herein, solid phase matrix can be used for nematode crop protection on root stock and slip crops. Field trials with plantain root stock and casava slips were performed.

Wrap and plant trial in management of plantain (Musa AAB, cv. Agbagba) nematodes

Objective: To determine the efficacy of abamectin-treated banana paper in the management of plantain nematodes.

Source of planting material: Plantain suckers (Musa AAB, cv. AGBAGBA) were collected as planting material from the IITA plantain breeding field. The suckers were cleaned and disinfested by paring and immersing in boiling water for 30 s before planting.

Nematode inoculum: Plant-parasitic nematodes, recovered from infested plantain field were cultured on plantain suckers in the greenhouse for six months and used as a mixed infestation (Meloidogyne spp., Pratylenchus spp., Hoplolaimus spp., and Radophoulus similis) of soil in pots, into which suckers were planted. The nematode infested soils were mixed on a polythene sheet for the soil to be homogenized. About 3 sub-sample of soil were collected to determine nematode initial population.

Planting: Pared hot-water treated suckers were planted into 10-Liter pots containing infested soil. The treatments included Nematode Infested soil+hot water treated sucker only, Nematode Infested soil+untreated banana paper, and Nematode Infested soil+ABM-Treated banana paper with 6 replications each.

Parameters Assessed:

Growth parameters: Plant height, number of functional leaves and number of dry leaves, and root fresh weight at harvest.

Root damage Scoring: Root damage lesion scoring scale: Adapted from Speijer and De Waele (1997) where, Clean 0% to severe 100%.

Root knot nematode galling index using a scale of 1-5: No galling, clean=1, Slight galling=2, Mild galling=3, Moderate galling=4 and Severe galling=5.

Reproduction factor (RF) was calculated as final nematode density (Pf)/initial density (Pi)

Effect on Plant growth

No difference in plant growth parameters was observed (P>0.05) for plant height, number of fresh and dry leaves at 4 and 8 weeks after planting. The stem girth was significantly higher in the control than in the untreated and abamectin treated paper as shown in Table 13.

Effect on Nematode Damage on Plantain

Plantain suckers wrapped with abamectin treated paper had a significantly lower (P<0.05) galling and lesion damage as compared to suckers wrapped with non-treated paper and unwrapped suckers. It was evident that the abamectin treated paper greatly protected the roots from damage i.e. lesions and galling as illustrated in Table 14.

TABLE 13
Effects of abamectin-treated paper on plantain root
weight and root damage on nematodes infested soil

| | Root | Gall Root | Root Lesion | Feeder | Feeder |
|---|---|---|---|---|---|
| Treatment | weight (g) | (score) | (score) | Root Gall | Root Lesion |
| No paper | 126.73a | 4.33a | 9.17a | 4.00a | 20.00a |
| (control) | | | | | |
| Untreated | 46.70b | 2.167b | 3.33b | 2.17b | 3.33a |
| paper | | | | | |
| Abamectin- | 54.99b | 1.83b | 3.33b | 1.50b | 2.83a |
| paper | | | | | |
| LSD | 50.10 | 1.39 | 6.25 | 1.43 | 20.13 |

Effect on Final Nematode Densities

The density of the nematode genera Meloidogyne spp. was significantly lower in both the soil and root samples of abamectin treated and untreated pot trials as compared the control (no paper). Radopholus spp. density was significantly lower in root sample of abamectin treated and untreated paper pot trials as compared the control (no paper).

TABLE 14
Effects of abamectin-treated banana paper on plant-parasitic nematodes on plantain in pots

| | Nematode genera density in root/100 g | | | | Nematode genera density in Soil/Litre | | | |
|---|---|---|---|---|---|---|---|---|
| | Helicotylenchus | Meloidogyne | Hoplolaimus | Radopholus | Helicotylenchus | Meloidogyne | Hoplolaimus | Radopholus |
| Treatments | spp. | spp. | spp. | spp. | spp. | spp. | spp. | spp. |
| No paper (control) | 2396.60a | 308.58a | 59.30a | 50.08a | 1791.70a | 1583.39a | 0.00a | 0.00a |
| Untreated paper | 490.60a | 68.06b | 30.26ab | 10.78b | 1250.00a | 916.70b | 0.00a | 0.00a |
| Abamectin-paper | 512.30b | 54.19b | 15.52b | 6.57b | 666.70c | 708.30b | 0.00a | 0.00a |
| LSD | 862.74 | 141.01 | 39.67 | 35.10 | 319.39 | 459.76 | 0.00a | 0.00 |

Wrap and plant management of nematodes on cassava (Manihot esculenta Crantz)

### BACKGROUND

Cassava (Manihot esculenta Crantz) is an important staple crop recognized as a 21st century crop mostly for smallholder farmers and important for food security in the tropics. Cassava is a perennial woody shrub with an edible root, which grows in tropical and subtropical areas of the world.

Cassava is a drought-tolerant crop that can be grown in areas with uncertain rainfall patterns, which usually results in unsuccessful cultivation of many other crops. Recently, the world cassava production stands at 291 million tonnes with leading countries, such as Nigeria, Congo DR, Thailand, Indonesia ranked 1st to 4th respectively. The production in Africa was 177 million in 2017, and is regarded as the world largest cassava growing region (FAOSTAT 2019). Cassava is regarded as the most widely cultivated root crop in the tropical region and a crop that persistently contributes to food security, mainly because of its ability to store its matured edible roots in the ground for about three years.

Cassava production is faced with various problems, ranging from pests and diseases (cassava mosaic disease, cassava bacterial blight, cassava anthracnose disease, cassava bud necrosis, root rots, mealybugs, green mite, nematodes etc.), weather related problems, poor soil, land dilapidation, damage by livestock, danger imposed by excessive use of fertilizers, scarcity of cuttings, poor accessibility to markets, etc., which all impact the yield. Insect pests and plant diseases reduce cassava yields substantially, posing a threat to food security throughout the developing world.

Experiment Setup

The objective of the study was to determine the efficacy of abamectin treated paper for the management of root knot nematodes, Meloidogyne incognita, under greenhouse and field conditions. A greenhouse experiment was conducted in pots. The effect of the treatments, ABM-treated paper, non-treated paper and no paper (positive control, with nematode inoculation) and negative control (a non-inoculated control), was assessed on four cassava varieties: IBA 070593, TMS 30572, IBA 070539, TME 419. Four weeks after planting 10,000 eggs/J2 Meloidogyne incognita were inoculated uniformly across all treatments except for the uninoculated treatment.

The field study was conducted at the International Institute of Tropical Agriculture (IITA), Ibadan, Nigeria, located at latitude 7° 3′N and longitude 3° 45′E in the forest-Savannah agroecology. A nematode infested field was chosen and laid out in a Randomized Complete Block Design with six replications using cv TMS 30572, a root knot nematode susceptible variety. Three treatments were used: Abamectin-banana treated paper, Non-banana treated paper and control (no paper).

Parameters Measured:

Harvest parameters: Root fresh weight, tuber weight and number of tubers per plant.

Galling index of 1-5: No galling, clean=1, Slight galling=2, Mild galling=3, Moderate galling=4 and Severe galling=5.

Reproduction factor (RF) was calculated as final nematode density (Pf)/initial density (Pi)

Results

Greenhouse experiment: Depending on the cassava variety, the use of ABM-treated paper reduced final M. incognita population, lowered nematode RF, reduced tuber galling and led to higher tuber weights compared to non-treated paper and no paper treatments across the four cassava varieties (Tables 15-18).

TABLE 15
Effect of treatments on final nematode population, reproduction
factor, root galling, tuber galling, tuber weight, number of tubers/plant
and root weight using IBA 070593(white tuber) variety.

| | Nematode | | | | | | |
|---|---|---|---|---|---|---|---|
| | Population | | | | Tuber | Number | Root |
| | (Pf) | Reproductive | Root | Tuber | weight | of Tuber/ | weight |
| Treatments | Root/soil | factor (Rf) | galling | galling | (g) | plants | (g) |
| Non-Treated paper + | 4.96 | 9.62 | 3.00 | 0.25 | 0.34 | 0.25 | 14.57 |
| Meloidogyne incognita | | | | | | | |
| Meloidogyne incognita | 4.88 | 8.78 | 3.00 | 0.50 | 7.5 | 0.7 | 14.72 |
| alone | | | | | | | |
| Treated paper + | 4.52 | 4.01 | 3.00 | 0.00 | 9.07 | 2.25 | 11.40 |
| Meloidogyne incognita | | | | | | | |
| Control (no nematode) | 0.00 | 0.00 | 0.00 | 0.25 | 0.34 | 0.25 | 8.29 |
| LSD (P ≤ 0.05) | 0.35 | 4.87 | 1.46 | 0.70 | 14.78 | 3.59 | 7.75 |

TABLE 16
Effect of treatments on final nematode population, reproduction factor, root galling, tuber galling,
tuber weight, number of tubers/plant and root weight using IBA 070539 (yellow tuber) variety.

| | Nematode | | | | | | |
|---|---|---|---|---|---|---|---|
| | Population | | | | Tuber | Number | Root |
| | (Pf) | Reproductive | Root | Tuber | weight | of Tuber | weight |
| Treatment | Root + Soil | factor (Rf) | galling | galling | (g) | per plant | (g) |
| Non-Treated paper + | 4.19 | 3.18 | 2.50 | 0.25 | 0.16 | 0.25 | 3.81 |
| Meloidogyne incognita | | | | | | | |
| Meloidogyne incognita | 4.15 | 7.35 | 3.25 | 0.25 | 2.49 | 0.25 | 2.27 |
| alone | | | | | | | |
| Treated paper + | 3.98 | 1.03 | 3.00 | 1.50 | 3.89 | 1.25 | 4.19 |
| Meloidogyne incognita | | | | | | | |
| Control (no nematode) | 0.00 | 0.00 | 1.00 | 0.50 | 8.82 | 1.00 | 5.29 |
| LSD (P ≤ 0.05) | 1.03 | 8.71 | 1.77 | 1.22 | 11.67 | 1.28 | 3.72 |

TABLE 17
Effect of treatments on final nematode population, reproduction factor, root galling, tuber galling,
tuber weight, number of tubers/plant and root weight using TME 419 (white tuber) variety.

| | Nematode | | | | | | |
|---|---|---|---|---|---|---|---|
| | Population | | | | Tuber | Number | Root |
| | (Pf) | Reproductive | Root | Tuber | weight | of Tuber | weight |
| Treatment | Root + Soil | factor (Rf) | galling | galling | (g) | per plant | (g) |
| Non-Treated paper + | 4.89 | 7.78 | 3.00 | 0.00 | 13.21 | 1.50 | 7.44 |
| Meloidogyne incognita | | | | | | | |
| Meloidogyne incognita | 5.02 | 10.49 | 3.75 | 0.00 | 12.42 | 1.50 | 12.43 |
| alone(no paper) | | | | | | | |
| Treated paper + | 4.73 | 5.36 | 2.25 | 0.25 | 14.85 | 1.50 | 7.08 |
| Meloidogyne incognita | | | | | | | |
| Control (no nematode) | 0.00 | 0.00 | 1.00 | 0.00 | 16.31 | 1.50 | 7.88 |
| LSD (P ≤ 0.05) | 0.06 | 1.328 | 1.22 | 0.39 | 24.43 | 1.67 | 4.81 |

TABLE 18
Effect of treatments on final nematode population, reproduction factor, root galling, tuber galling,
tuber weight, number of tubers/plant and root weight using TMS 30572 (yellow tuber) variety

| | Nematode | | | | | | |
|---|---|---|---|---|---|---|---|
| | Population | | | | Tuber | Number | Root |
| | (Pf) | Reproductive | Root | Tuber | weight | of Tuber | weight |
| Treatment | Root + Soil | factor (Rf) | galling | galling | (g) | per plant | (g) |
| Non-Treated paper + | 3.49 | 0.33 | 2.75 | 0.25 | 0.17 | 0.25 | 12.16 |
| Meloidogyne incognita | | | | | | | |
| Meloidogyne incognita | 4.08 | 1.33 | 3.50 | 0.25 | 1.01 | 0.50 | 5.1 |
| alone | | | | | | | |
| Treated paper + | 3.42 | 0.27 | 2.7 | 0.75 | 8.18 | 0.75 | 7.61 |
| Meloidogyne incognita | | | | | | | |
| Control (no nematode) | 0.00 | 0.00 | 1.00 | 0.00 | 0.00 | 0.00 | 2.92 |
| LSD (P ≤ 0.05) | 0.25 | 0.53 | 1.69 | 0.92 | 10.88 | 1.13 | 13.22 |

Field Trial:

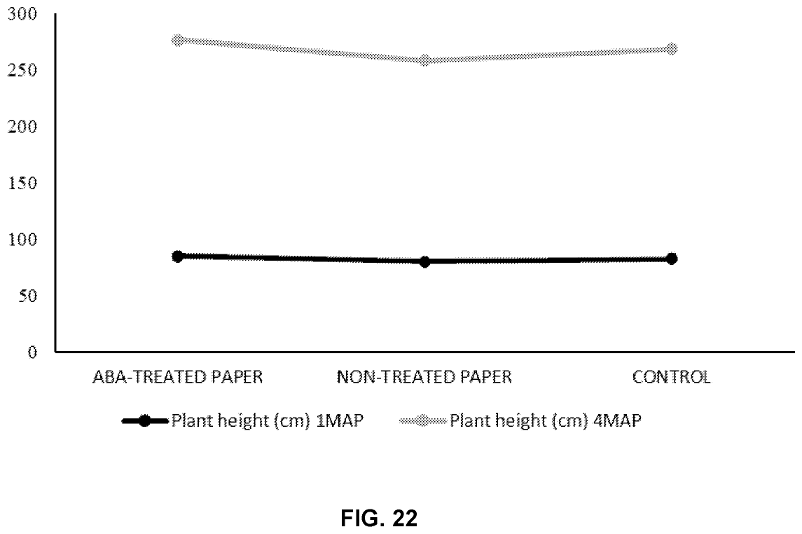

The growth parameters: germination/sprouting, plant height and number of branches assessed within 4 months of growth showed no differences between treatments (Table 19, FIG. 22). At harvest, average tuber weight per plant and number of tuber/plants were significantly higher (P<0.05) in plants with ABM-treated paper compared to the control (Table 20). Number of galls produced per plant and tuber galls were significantly higher in plants with either no paper (control) or untreated banana paper (Table 20).

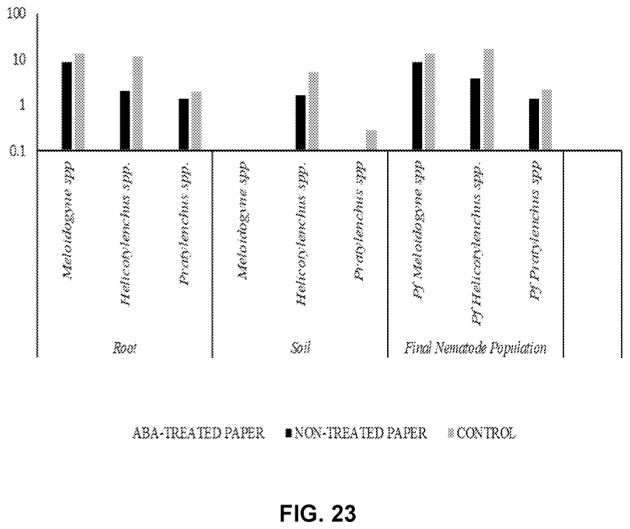

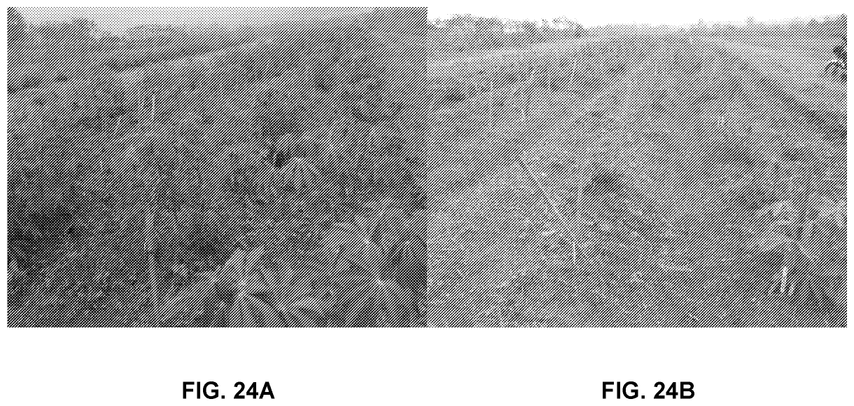

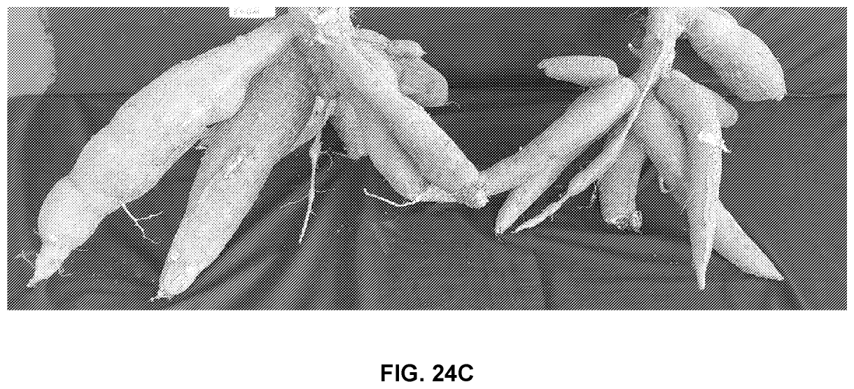

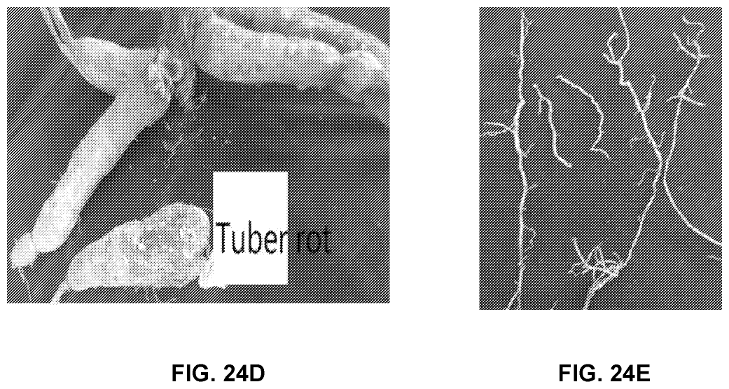

Nematodes recovered from the roots and soil at harvest, showed that ABM-treated paper had a significant effect in reducing plant-parasitic nematodes. Root-knot nematode (Meloidogyne spp.), spiral nematode (Helicotylenchus spp.) and Pratylenchus spp. densities were significantly higher from no paper and non-treated paper compared with ABM-treated banana paper (FIG. 23).

TABLE 19
Effect of Abamectin-treated banana paper on the growth of cassava

| | | Plant height | Number of | Plant height |
|---|---|---|---|---|
| | % | (cm) | branches | (cm) |
| Treatments | sprouting | 1MAP | 1MAP | 4MAP |
| ABA-banana treated | 4.056a | 84.76a | 1.67a | 192.13a |
| paper | | | | |
| Non-banana treated | 3.61a | 80.37a | 1.68a | 177.78a |
| paper | | | | |
| Control (no paper) | 3.89a | 82.65a | 1.58a | 185.89a |
| LSD (P < 0.05) | 0.74 | 9.13 | 0.22 | 12.98 |

Note:
MAP = month after planting

TABLE 20
Effect of Abamectin-Banana treated paper on the yield and tuber damage

| | Tuber weight/ | Number of Tuber/ | Fresh root | Number of gall | Tuber galling |
|---|---|---|---|---|---|
| Treatments | plant (kg) | plants | weight (g) | on root | (score) |
| ABA-Banana treated | 6.96a | 3.84a | 14.01a | 0.14b | 1.00b |
| paper | | | | | |
| Non-banana treated | 5.72ab | 2.79ab | 9.09a | 1.31a | 1.22a |
| paper | | | | | |
| Control (No paper) | 5.06b | 2.23b | 8.29a | 1.17a | 1.34a |
| LSD (P < 0.05) | 1.29 | 1.16 | 9.08 | 0.39 | 0.18 |

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1. A solid phase matrix comprising a layer of lignocellulosic fibers,
wherein at least 50% of the lignocellulosic fibers have an average length of from 0.5 to 50 mm, and
wherein the lignocellulosic fibers comprise banana pulp fibers in an amount of from 10 wt % to 90 w % of the solid phase matrix.

2. The solid phase matrix of claim 1, wherein the lignocellulosic fibers further comprise wood or recovered paper fibers.

3. The solid phase matrix of claim 2, wherein the wood or recovered paper fibers comprises old corrugated cardboard (OCC).

4. The solid phase matrix of claim 1, wherein the lignocellulosic fibers further comprise fibers from non-banana plants.

5. The solid phase matrix of claim 4, wherein the non-banana plants are selected from the group consisting of wheat, rice, bagasse, bamboo, gampi, rush, and mulberry.

6. The solid phase matrix of claim 1, wherein the matrix has an air resistance less than 500 Gs.

7. The solid phase matrix of claim 6, wherein the matrix has an air resistance of less than 250 Gs.

8. The solid phase matrix of claim 1, wherein the matrix has a water sorbency of at least 0.1 mg/gm, and a water absorbency of at least 0.01 mg/gm.

9. The solid phase matrix of claim 1, wherein the matrix has a burst index less than 15 kPa·m²/g.

10. The solid phase matrix of claim 9, wherein the matrix has a burst index less than 5 kPa·m²/g.

11. The solid phase matrix of claim 1, wherein the matrix has a basis weight less than 200 gsm.

12. The solid phase matrix of claim 11, wherein the matrix has a basis weight less than 125 gsm.

13. The solid phase matrix of claim 1, wherein the banana pulp fibers are derived from the banana plant rachis, penducle, pseudostem, fruit peel, leaves or any combination thereof.

14. The solid phase matrix of claim 13, wherein the banana pulp fibers are mechanically disintegrated.

15. The solid phase matrix of claim 1, wherein the banana pulp fibers are produced from a pulp having a Canadian Standard Method (CSF) test freeness of from 300-700.

16. The solid phase matrix of claim 15, wherein the banana pulp fibers are produced from a pulp having a CSF test freeness of 500 to 650.

17. The solid phase matrix of claim 1, where the matrix has a small molecule absorbance capacity of at least 1 mg/gm for neutral compounds, at least 300 μg/gm for positively charged compounds, and at least 150 μg/gm for negatively charged compounds.

18. The solid phase matrix of claim 17, further comprising an agrochemical internalized to the solid phase matrix.

19. The solid phase matrix of claim 18, wherein the agrochemical is a pesticide, herbicide, nematocide, fungicide, insecticide, micronutrient, fertilizer, or plant growth regulator or combination there of.

20. The solid phase matrix of claim 19, where the agrochemical is abamectin or fluopyram.

21. The solid phase matrix of claim 18, where the half-life of the agrochemical in the soil is increased by at least 200% when absorbed into the solid phase matrix.

22. The solid phase matrix of claim 1, wherein the layer of lignocellulosic fibers further comprises a dry or wet strength additive.

23. The solid phase matrix of claim 1, where the matrix comprises pores having an average diameter of 1 to 3 mm.

24. The solid phase matrix of claim 23, where the pores are present at a density of 200 to 600 pores per m².

25. The solid phase matrix of claim 1, where the matrix is folded into a pouch sized to accommodate a root stock, plant seed, seed piece, seedling, or slip.

26. The solid phase matrix of claim 1, where the matrix is shredded or configured as a pellet for sustained release of an agrochemical in or on soil.

27. The solid phase matrix of claim 1, where the matrix is configured as a liner in a planting container.

28. A mechanized planter, comprising: 1) a hopper configured to be filled with a plant seed, seed piece, seedling, or slip, 2) hopper configured to feed the solid phase matrix of claim 1, 3) a mechanism for wrapping or encasing the plant seed, seed piece, seedling, or slip into the solid phase matrix, and 4) a mechanism for planting the wrapped or encased plant seed, seed piece, seedling, or slip into a soil.

29. A method for protecting a plant or plant part, comprising wrapping or encasing the plant or plant part in the solid phase matrix of claim 1 prior to planting.

30. A method of making banana pulp fibers, comprising cutting the banana plant or plant part in small pieces and soaking it in water for mechanical disintegration into pulp fibers.

31. A method of making banana paper matrix, comprising slurry making and refining of banana pulp fibers and forming in a paper matrix via drainage, pressing and drying.

32. The method of claim 31, further comprising internal or surface additives selected from the group consisting of dry strength agents, wet strength agents, and sizing agents.
